(19) United States
(12) Patent Application Publication
(10) Pub. No.: US 2015/0310757 A1
(43) Pub. Date: Oct. 29, 2015

(54) METHOD AND APPARATUS ENABLING A CASE-STUDY APPROACH TO ONLINE LEARNING

(71) Applicant: President and Fellows of Harvard College, Cambridge, MA (US)

(72) Inventors: Youngme MOON, Brookline, MA (US); Bharat ANAND, Wellesley, MA (US); Nitin NOHRIA, Boston, MA (US); Janice HAMMOND, Belmont, MA (US); Vilangadu Gopal NARAYANAN, Newton, MA (US)

(21) Appl. No.: 14/693,302

(22) Filed: Apr. 22, 2015

Related U.S. Application Data
(60) Provisional application No. 62/006,757, filed on Jun. 2, 2014.
(60) Provisional application No. 61/983,066, filed on Apr. 23, 2014.

(51) Int. Cl. G09B 7/04

(52) U.S. Cl. CPC G09B 7/04

(57) ABSTRACT

A system and method for offering to a large pool of students a loosely synchronous online course that facilitates student interactions and behavior to emulate a physical case-study classroom. The large pool of students is divided into cohorts of a smaller number of students. Course content is divided into lessons and lesson content is released according to a schedule so that an individual student may progress through a course relatively independently but which prohibits a student from progressing to a subsequent lesson until a defined release date. Content within a lesson is selected in response to an interaction by the student with the content and with other students, so that interactions of a cohort with the content in a lesson influences the selection of subsequent content for the lesson, and in which interactions of a student with the stored content becomes student derived content to be shared with the cohort.

### CROSS REFERENCE TO RELATED APPLICATIONS

This application claims priority to U.S. Application No. 61/983,066, filed Apr. 23, 2014, entitled “Distance Learning Platform,” and to U.S. Application No. 62/006,757, filed Jun. 2, 2014, entitled “Method and Apparatus Enabling a Case-Study Approach to Online Learning,” the entire contents of which are incorporated herein by reference.

### TECHNICAL FIELD

This disclosure relates generally to an online learning system and method, and more specifically to an apparatus and method for a state-based loosely-synchronous environment to enable a case study approach to online learning which facilitates a high degree of interaction among students and with course content.

### BACKGROUND

There are two types of teaching models generally employed in classrooms. The first is a lecture model, which usually includes a professor at a lectern with a blackboard lecturing to a large group (e.g., an undergraduate class at a university). The lecture model is a generally passive form of learning. The goal of a lecture-based approach to teaching is to distribute knowledge.

A second type of teaching model is the case study approach. The case study approach generally involves fewer students and focuses on student engagement and active learning. One of the goals of the case study approach is to involve students more actively in the learning process. In the case study approach, students are incentivized to stay alert by cold calls, prompted to debate among themselves in front of others, and encouraged to engage in critical thinking and intuition building exercises.

Online courses have traditionally followed a lecture model. One type of online course is a Massive Online Open Courses (MOOC). A MOOC allows a large number of students to participate in a class. A traditional MOOC, similar to a lecture model, focuses on disseminating information first and having students think about the material after class.

### SUMMARY

According to some embodiments of the present disclosure, a system is configured to offer to a large pool of students a loosely synchronous online course that facilitates student interactions and behavior to emulate a physical case-study classroom, in which course content and student responses are critical to learning, the system comprising a user registration module, configured to divide the large pool of students into cohorts of a smaller number of students, each cohort being a subset of the students; course content stored in a computer-readable storage medium, the content being divided into lessons and the content comprising combinations of social, passive, active and adaptive teaching elements and in which the teaching elements include computer rules and logic to specify synchronization points at which students within a cohort are to interact among one another or at which students within a cohort synchronize their individual progression through the course content; and content selection and scheduling logic that releases lesson content according to a defined schedule so that an individual student may progress through a course relatively independently and at his or her own pace but which prohibits a student from progressing to a subsequent lesson until a defined release date for that lesson so that students with a cohort will synchronize their progress through the course at least at the defined release dates, and that selects content within a lesson in response to an interaction by the student with the content and with other students, so that interactions of a cohort with the content in a lesson influences the selection of subsequent content for the lesson, and in which interactions of a student with the stored content becomes student derived content to be shared with the cohort, such that each student progresses through the course relatively independently and is loosely synchronized at defined points with other students in the same cohort in a manner that emulates student interaction in a physical case-study classroom.

In some embodiments, a passive teaching element comprises logic to deliver media to a student. In some embodiments, a social teaching element comprises logic to provide for student interaction with the cohort in response to a combination of the stored content and the student derived content. In some embodiments, an active teaching element comprises logic to provide for student interaction with the stored content such that the student responds to the stored content. In some embodiments, an adaptive teaching element comprises logic to analyze a prior response of an individual student and to provide stored content conditioned on the prior response of an individual student to help the student learn from his or her own responses. In some embodiments, the content selection logic selects two or more students in a cohort for further interaction based on the student derived content. In some embodiments, the content selection logic selects the two or more users based on a semantic analysis of the student derived content such that the two or more students are selected based on opposing viewpoints. In some embodiments, the further interaction comprises a defined point where students in a cohort are loosely synchronized. In some embodiments, the student derived content is a student response received based on a trigger point within a teaching element, the trigger point comprising an insertion point at a designated time within a teaching element where additional content is delivered. In some embodiments, the trigger point is one of two or more trigger points, wherein each trigger point is associated with different content, and the content selection logic randomly chooses the trigger point to serve to a student.

### BRIEF DESCRIPTION OF FIGURES

FIG. 1 is a conceptual diagram depicting categories of course platform features, according to some embodiments of the invention.

FIG. 2 is a flowchart of course hierarchy and teaching element types, according to some embodiments of the invention.

FIG. 3 is a teaching platform logical entity model, according to some embodiments of the invention.

FIG. 4 is a diagram depicting a teaching element ecosystem, according to some embodiments of the invention.

FIG. 5A is a diagram depicting a logical architecture of the course platform, according to some embodiments of the invention.

FIG. 5B is another diagram of a logical architecture of the course platform, according to some embodiments of the invention.

FIG. 6 is a diagram depicting a software architecture for the course platform, according to some embodiments of the invention.

FIG. 7 is a screenshot depicting a class directory and a geolocation feature, according to some embodiments of the invention.

FIG. 8 is a screenshot depicting a one-to-one messaging feature, according to some embodiments of the invention.

FIG. 9 is a screenshot depicting a student dashboard, according to some embodiments of the invention.

FIG. 10 is a screenshot showing a detailed view of the My Progress tab on the course dashboard, according to some embodiments of the invention.

FIG. 11 is a screenshot showing a view of a syllabus, according to some embodiments of the invention.

FIG. 12 is a screenshot showing an example of one-to-one messages in a communication window, according to some embodiments of the invention.

FIG. 13 is a screenshot showing an I Need Help Feature, according to some embodiments of the invention.

FIG. 14 is a screenshot showing a group discussion feature, according to some embodiments of the invention.

FIG. 15 is a screenshot showing a cold call, according to some embodiments of the invention.

FIG. 16 is a screenshot depicting a course specific teaching element, according to some embodiments of the invention.

FIG. 17 is a screenshot showing another course specific teaching element, according to some embodiments of the invention.

FIG. 18 is a screenshot showing another course specific teaching element, according to some embodiments of the invention.

FIG. 19 is a screenshot showing a shared reflection, according to some embodiments of the invention.

FIG. 20 is a screenshot showing a poll, according to some embodiments of the invention.

FIG. 21 is a screenshot showing an example of courseware tools, according to some embodiments of the invention.

FIG. 22 is a screenshot showing an example of a trigger point, according to some embodiments of the invention.

FIG. 23 is a screenshot showing an example of multiple choice, according to some embodiments of the invention.

FIG. 24 is a screenshot showing an example of nested multiple choice, according to some embodiments of the invention.

### DETAILED DESCRIPTION

The invention relates to systems and methods for offering a state-based loosely-synchronous online course platform.

Preferred embodiments of the present invention enable a student to participate in a highly engaging, highly interactive case-study style of learning. A MOOC is created that can simulate the feel of a small classroom, while allowing students to log into the course from anywhere in the world and at any time of day. The platform divides students up into cohorts of 10-1000 students. The size of a cohort can vary depending on the course. For example, when a course requires multiple students to be online at the same time, the cohort number may be higher to ensure that students, regardless of their location or work habits, will have other students online at the same time.

A cohort proceeds through a course together in loose, state-based synchronicity, held together by system imposed rules, individual progress, and student choice. While a student can proceed through the course at his or her own pace, the platform loosely gates the student by releasing certain modules at set points throughout the course so that no one in a cohort is too far behind or ahead of another. The system also can gate a student by providing various tasks to finish before he or she can move onto to the next module. The student's progress is also tied to those of his or her peers. Collaboration is encouraged and group work can be built into the platform as a gating function. Smaller groups are formed by the platform throughout the course based on the students' progress. Some modules do not unlock until a smaller group completes a task. The platform also promotes active learning by keeping a student alert with trigger points. Trigger points can occur randomly throughout the course and present the student with cold calls, free response, and multiple choice sets. A student's response and progress is viewable by his or her peers, and participation is encouraged by linking a student's score with the number of questions posed to the class and number of colleague's questions that a student answers. The platform encourages a student to actively engage in the material and the opinions of his or her peers. Students can rate a peer's question and/or answer in peer help 156, which provides feedback that provides the system with data to highlight posts that will be most helpful. In this fashion, an environment is created which emulates a case-study lecture room, and which facilitates and actively encourages that style of learning.

Preferred embodiments of the present invention provide an online course that promotes the principles of case-study learning. In some embodiments, the course platform provides a technical solution to bringing case-study learning elements online. In some embodiments, the course platform supplements a real-world classroom.

Preferred embodiments of the present invention provide an online course where an instructor can construct a case-study learning course. The platform provides an instructor with teaching elements to build his or her course. As in a traditional classroom, but not as in a traditional MOOC, teaching elements can fall into one or more of four categories: passive, active, adaptive and social. As discussed below, an instructor can combine teaching elements from different categories to build an engaging experience for the student. An instructor can mix lectures with active elements such as cold calls, intuition builders and polls. An instructor can encourage a student to engage with material by giving him or her nested multiple choice question sets and drills. An instructor can condition a student's progression to a subsequent module based on team exercises and peer help.

As described in more detail below, the platform offers the flexibility of an asynchronous learning platform by allowing students to watch lectures and complete coursework at any time of day. Students in different time zones, with different work schedules and different work habits can all participate in the same course. The platform also offers the benefits of a synchronous learning platform by enabling and encouraging collaboration among students. In a case study approach, students are encouraged to learn from their peers. In many instances, there is more than one “right” answer to a question. The “right” answer can be shaped by location, age and experience. In some cases, having the insight of classmates from around the world and of differing backgrounds enhances a student's understanding of the right answer. Embodiments of the present invention allow students to develop profiles and view profiles of others in their class. Students are encouraged see how their peers think through polls, free responses, sharing photos, and team exercises.

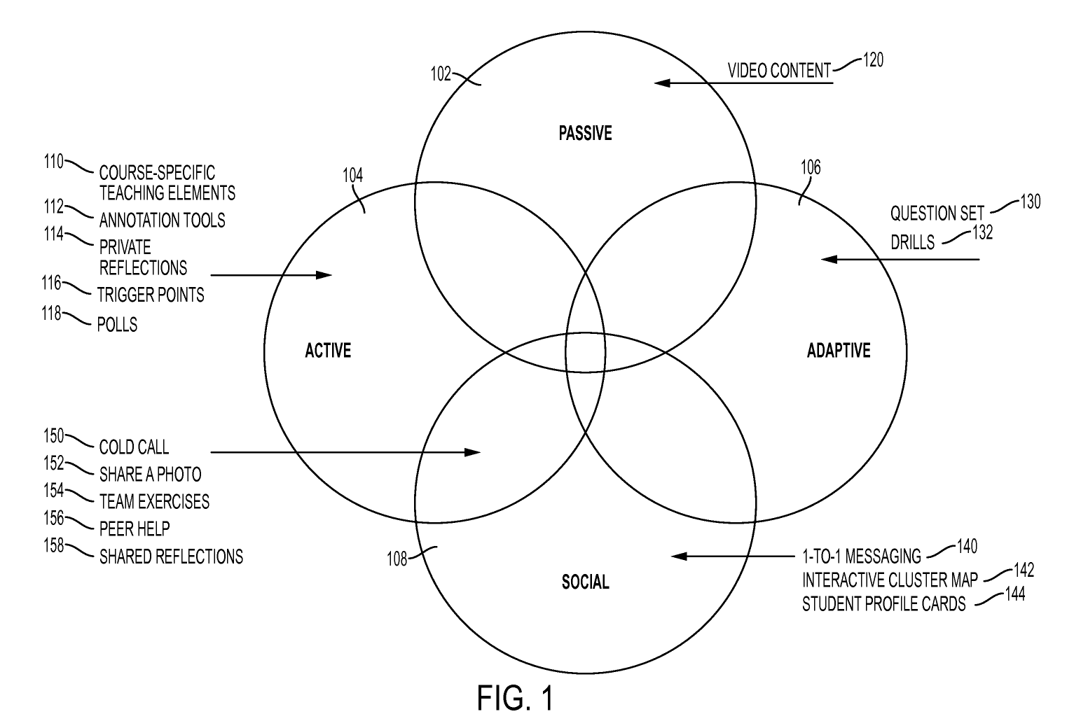

FIG. 1 is a conceptual diagram depicting categories of course platform features, according to some embodiments of the invention. It shows a passive category 102, an active category 104, adaptive category 106, and a social category 108.

As discussed above, in a case-study approach, an instructor can combine passive, active, adaptive and social elements to keep students engaged in a classroom. An example of a passive element in the classroom is a lecture. A lecture, in and of itself, does not require any student interaction other than for the student to listen. An example of an active element in a classroom is taking notes. Marking up class materials is a form of active engagement with the material. A student's notes reflect his or her own thoughts and questions about the material. An example of an adaptive element in a classroom is a student being led by an instructor through a series of questions. In response to a student comment or answer, an instructor can follow up with additional questions. The instructor can adapt his or her questions based on the student's responses. In some embodiments, the instructor, through a series of questions, can help lead a student through logical steps to demonstrate the accuracy or inaccuracy of a student's response. An example of a social element in a traditional classroom is group discussion. Group discussion includes instructor facilitated group discussion within a classroom, or students discussing in small groups outside the classroom. An observer model allows faculty and staff to view the interactions in the platform without progressing through the course as a student and to intervene if there are questions around content. This view also facilitates grading; observers can mark denote strong comments and answers posted in the I Need Help feature 1206.

Similar to a traditional classroom, an instructor can create an engaging learning experience on the course platform by integrating features from passive, active, adaptive and social categories.

As in a traditional classroom, passive features 102 on the course platform do not require or require minimal user interaction. Video content 120 is an example of a passive feature. A student's interaction with video content is often limited to starting, pausing or stopping a video.

Active features 104 include features presented to the student to engage with in order to progress through the course in sequence (e.g., unlocking new content as they complete each module, lesson, and concept). The platform is able to provide similar and additional active features when compared with those found in a traditional classroom. Examples of active features 104 on the course platform are course specific teaching elements 110, annotation tools 112, private reflections 114, trigger points 116 and polls 118. These features are described in more detail below.

Adaptive features 106 include content that adjusts based on what the system knows about the student's progress, learning style, or other attributes used to form a profile. Similar to an instructor customizing questions based on a student's response, the platform can use metadata from a student's platform experience and provide additional questions and links based on the metadata. As discussed in more detail below, the metadata can include time spent on an exercise, number of questions answered correctly, types of question answered correctly, etc. In addition to question sets 130, adaptive features 106 on the platform can also include drills 132.

Social features 108 include features that facilitate the ability for students to discover and connect with each other as they journey through the course together as a cohort. The social features 108 on the platform mimic and enhance the social experience in a traditional classroom. Examples of social features 108 are One-to-One Messaging 140, Interactive Cluster Map 142 and Student Profile Cards 144. These features are described in more detail below.

Some features encompass more than one category. For example, teaching elements can be both active and social. Examples of features that are both active and social are cold call 150, share a photo 152, team exercises 154, peer help 156 and shared reflections 158. These features are described in more detail below.

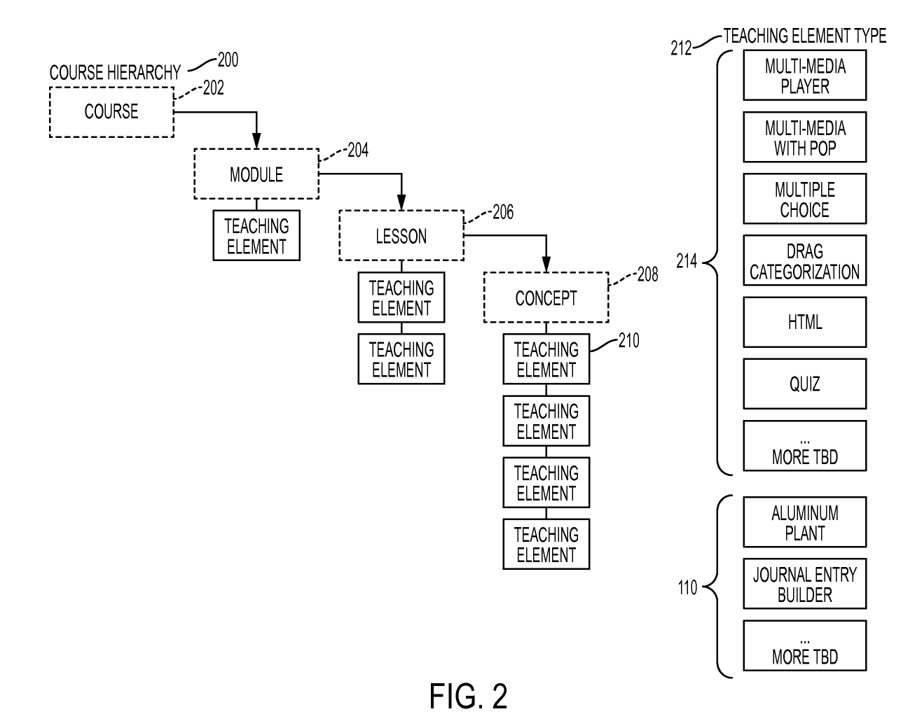

FIG. 2 is a flowchart of course hierarchy and teaching element types, according to some embodiments of the invention. It shows a course hierarchy 200 including a course 202, a module 204, a lesson 206, a concept 208, and teaching elements 210. Teaching element types 212 include standard teaching elements 214 and course specific teaching elements 110.

As discussed above, a case-study approach to learning shifts the focus from disseminating information, as in a lecture-based model, to active learning, where the student learns through peer interaction and intuition building exercises. To keep students engaged in a traditional case-study approach classroom, an instructor can design a course that integrates passive, active, adaptive and social elements. Similarly, the course platform can provide instructors with teaching elements to design a course integrating passive, active and social elements. For example, an instructor can design a course that begins with a passive teaching element (e.g., a video) and follows with an adaptive teaching element (e.g., a nested multiple choice), a social element (e.g., a group discussion), another passive teaching element (e.g., a video), and an active teaching element (e.g., a cold call).

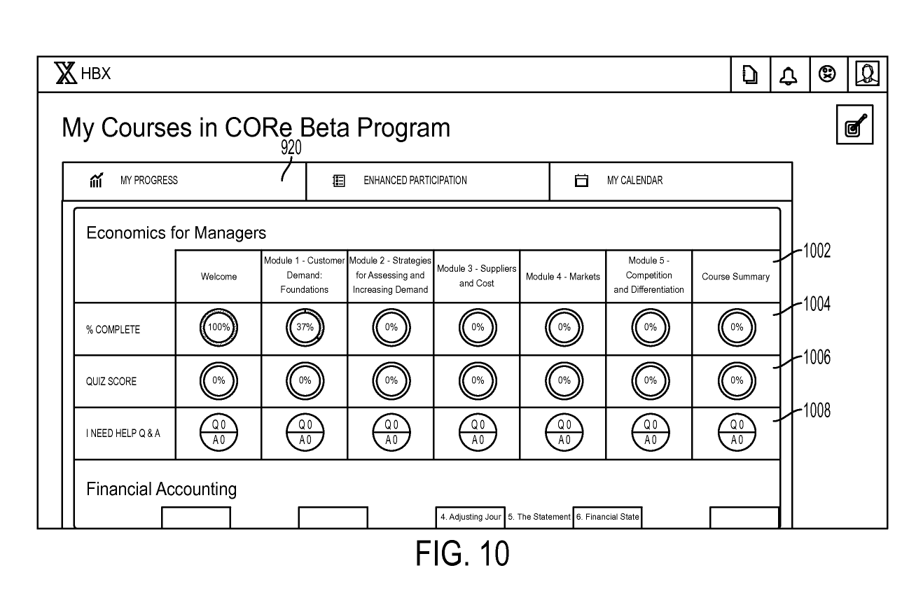

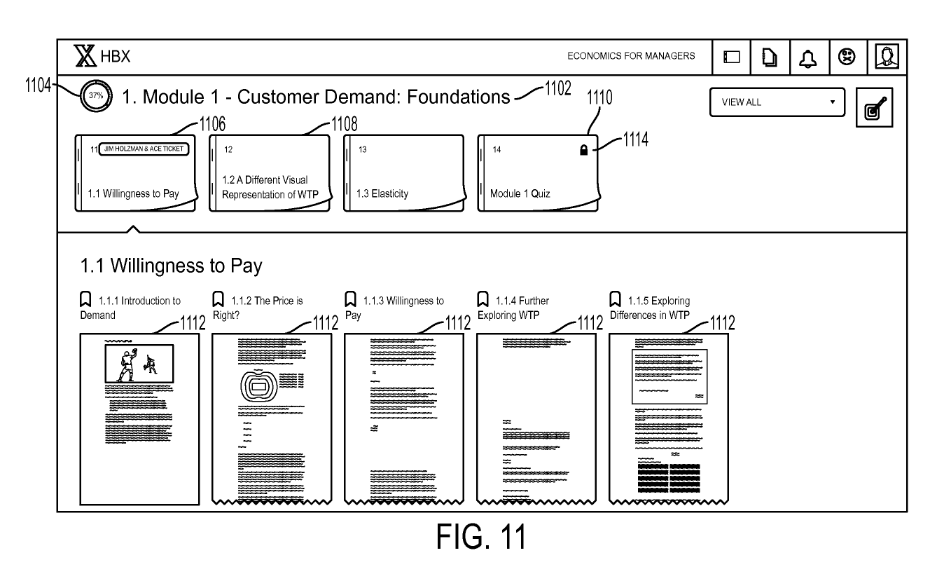

Teaching elements are the building blocks of the platform. Courses include one or more teaching elements. Teaching elements can include standard teaching elements 214 and course specific teaching elements 110. Standard teaching elements 214 are available to all courses. Examples of standard teaching elements include a multi-media player, multi-media with pop, multiple choice, HTML, and Quiz. Course specific teaching elements are teaching elements built specifically for a single course. Examples of course specific teaching elements include an elasticity intuition builder and a random sample generator, as described in FIGS. 10 and 11 below.

Teaching elements are designed specifically for the course platform. As discussed in more detail below, a course developer builds teaching elements that conform to a set of parameters. Briefly, teaching elements are built with similar abilities to send and receive metadata. For example, an intuition building teaching element and a media player teaching element can both track an amount of time a student spends on a teaching element, an amount of time before a student interacts with a teaching element, number of interactions with the teaching element, and points in a teaching element a student spends the most amount of time.

In some embodiments, the platform can include a loose set of rules governing the number and order of teaching element types. For example, a platform can require an instructor to include at least one of an active, adaptive, or social teaching element following a passive teaching element. A platform can also set a threshold for a number of passive, active, adaptive, and social teaching elements per course. As described in more detail below, analytics taken from students' interaction with the course can inform a set of rules governing course structure.

Teaching elements can also be organized into hierarchical layers. Similar to a course offered in a traditional classroom, a course offered on the platform can be broken into smaller subsections (e.g., module, lesson, concept). While in some embodiments a course hierarchy can include a course, module, lesson, and concept, the number of layers in a course hierarchy can be fewer or greater depending on the course and the instructor. For example, if an instructor offers a relatively simple course with only a few divisions of course matter, the instructor can utilize fewer layers in a course hierarchy. If an instructor offers a more complex course, the instructor can specify more layers in a course hierarchy.

Modules 204, lessons 206, and concepts 208 are containers for course organization. Modules 204 can contain 0 or 1+lessons 206, and lessons 206 can contain 0 or 1+concepts 208. Modules 204, lessons 206, and concepts 208 can contain 1 or more teaching elements 210. As described above, teaching elements are the building blocks of a course.

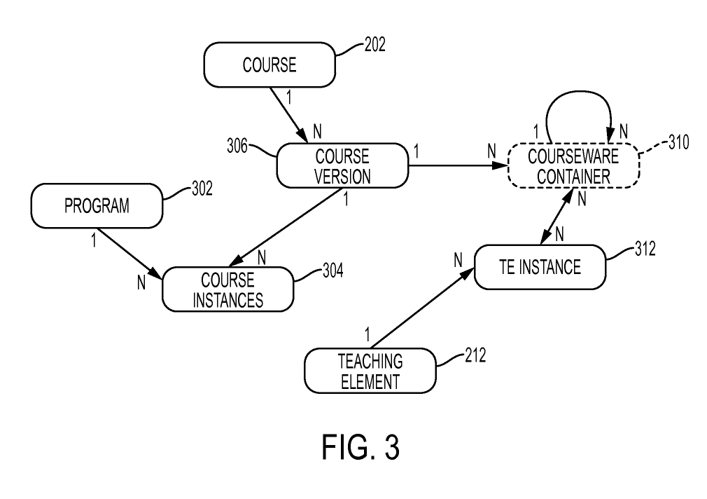

FIG. 3 shows a teaching platform logical entity model, according to some embodiments of the invention. It shows a program 302, course instances 304, course version 306, a course 202, a courseware container 310, a teaching element instance 312, and a teaching element 212.

A program implementing the platform described herein is flexible and can be adapted to a number of situations. A program instance can be composed of multiple courses. Courses can be versioned to facilitate change and historical tracking. A flexible n-level hierarchy can be used for structuring course materials. Teaching element instances can be reused across courses.

A program 302 is a container for courses. Programs can vary by topic or by time period. For example, programs can be a business school core skills program or a business school advanced skills program. Programs can also be a Fall of 2015 Core skills program and a Fall of 2016 Core skills program. For every one program, there can be n number of course instances 304. Course instances for a core skills program can include Economics, Financial Accounting and Business Analytics.

A course version 306 can also include n number of course instances. For example, Economics version 1.0 can be Fall of 2015 Economics version 1.0 or Fall of 2016 Economics version 1.0. A course 202 can include n number of course versions. For example, Economics can include Economics version 1.0 or Economics version 2.0. Economics can also include Economics Fall of 2015 and Economics Fall of 2016.

A course version 306 can also include n number of courseware containers 310. As described above, a course can contain any number of layers of sub-dividers. For example, a course can contain a lesson, a module, and a concept. A course can also contain a subset of those layers or additional layers. Courseware containers can contain n number of teaching element instances. For example, in one embodiment, a lesson, module and concept can all include teaching elements. In another embodiment, a lesson and module do not have teaching elements while a concept includes teaching elements.

N number of teaching element instances 312 can be created from a teaching element type 212. For example, elasticity teaching element version 1 and elasticity teaching element version 2 can be created from an elasticity teaching element type.

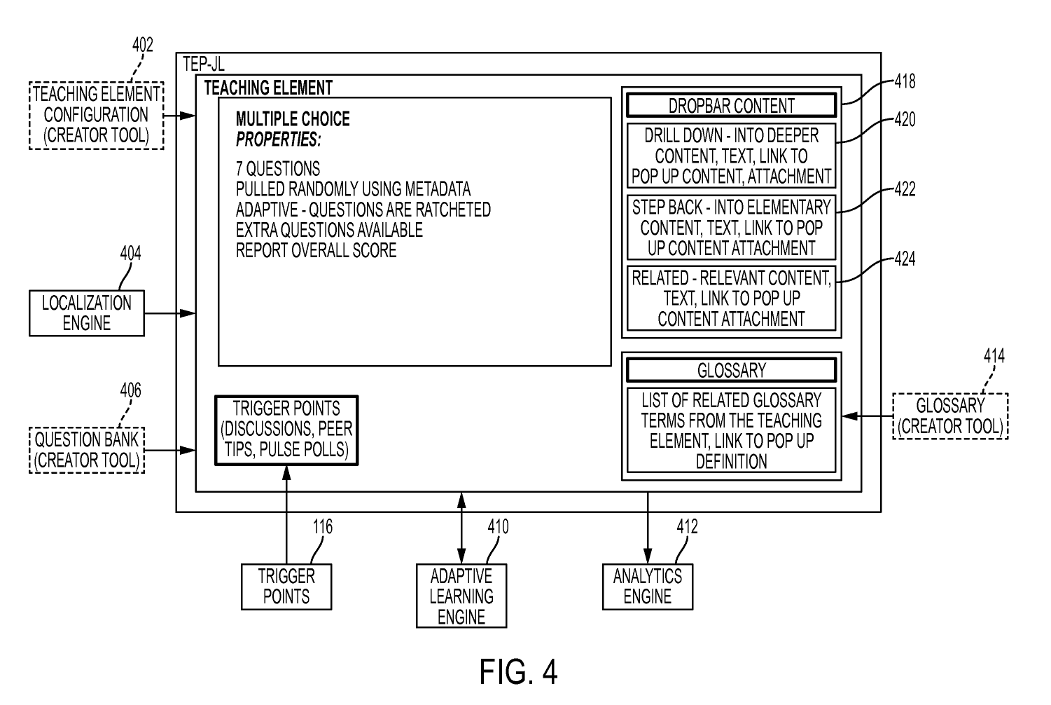

FIG. 4 shows a teaching element ecosystem, according to some embodiments of the invention. It shows a teaching element ecosystem including a teaching element configuration tool 402, a localization engine 404, a question bank 406, trigger points 116, adaptive learning engine 410, analytics engine 412, a glossary 414, and a drop bar 418 including drill down 420, step back 422, and related content 424.

A teaching element can have a teaching element configuration tool 402. As discussed above, course instructors can assemble teaching elements. The teaching element configuration tool 402 allows an instructor to embed a new teaching element with teaching element properties. Teaching element properties include general properties, teaching element type specific properties, drop bars 418, trigger points 116 and metadata.

A localization engine 404 provides content to a teaching element in a language selected by the student. Localization can apply to an overall course. For example, a student can be associated with a language or language/country pair at the outset of a course and the selection can then be applied to the various courses and teaching elements in those courses. In some embodiments, the student can select a language. As discussed in more detail below, the platform can also automatically detect a user's location and suggest a language. The localization engine 494 can receive the suggested language and provide content in the suggested language.

A question bank 406 includes a set of questions stored externally from the teaching element. Questions can be pulled from the bank either by ID or randomly using metadata. A course author can select how the question bank is accessed when configuring teaching elements within a course.

Trigger points 116, as discussed above, are points in a course an instructor can designate for an object instantiation. Options for teaching elements such as a discussion or poll are triggered at specific events in teaching elements. For example, a teacher can embed trigger points in a video to reinforce a particular concept.

Adaptive Learning Engine 410 uses metadata to generate additional material for a student. For example, the adaptive learning engine 410 can designate which questions to pull out of the question bank 406 based on a student's prior performance. The adaptive learning engine 410 can also provide responses and next steps to teaching elements based on a student's answer. As discussed above with the nested multiple choice, a user's answer to one question can lead to a corresponding set of additional questions. The adaptive learning engine 410 can also save a student's performance information for the skills assessment module.

Analytics Engine 412 can collect and store all student activity by student, teaching element, event, timestamp, IP, address, etc. The engine 412 can be used to generate reports. The results of the engine 412 can also be used to revise teaching element configuration and placement for future courses.

Glossary 414 can include a list of terms for a course. Glossary items can appear based on the content currently displayed in a teaching element. For example, if a student is currently in an elasticity teaching element, the student can also see terms related to elasticity such as price, quantity, revenue and elasticity. In a preferred embodiment, a glossary is created and mapped to a course when content is rendered within a teaching element and the teaching element is glossary-enabled by the course creator. The terms that appear in the Glossary 414 can be highlighted for the user to click on to see the definition.

A dropbar 418 can be an optional feature and is a teaching element type. Dropbar content can be presented below an existing teaching element to prevent navigation. If the dropbar content is a teaching element, no associated sidebar content is shown. If the content is not teaching element, the sidebar content can include a drill down 420, a step back 422, and related content 424.

Drill down 420 can provide a link to text, pop up content, an attachment or exercises that delve deeper into the content. A user can choose drill down 420 when they are comfortable with the material and want to explore particular concepts in more detail.

Step back 422 can provide a link to text, pop up content, an attachment or exercises that include elementary content. For example, a user can choose step back 422 when they have missed a lot of questions in a multiple choice set or generally feel uncomfortable with the material.

Related content 424 can provide a link to text, pop up content, an attachment or exercises that include content relevant to the content presented in the corresponding teaching element. For example, a student in an elasticity teaching element can find a revenue teaching element in the related content section.

Dropbar content can be referenced when configuring a Teaching Element. Dropbar content items are all Teaching Element instances.

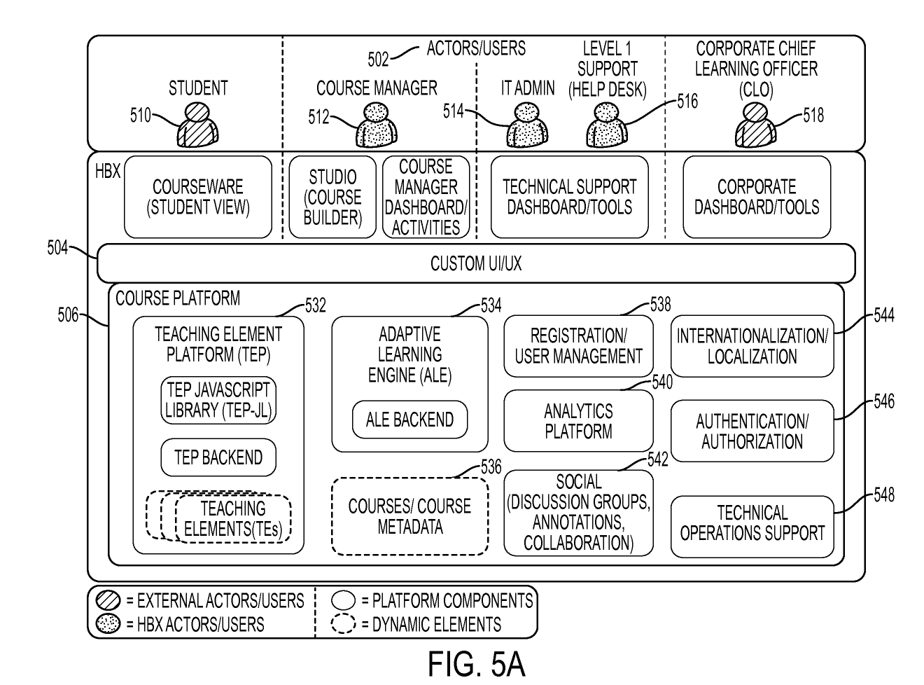

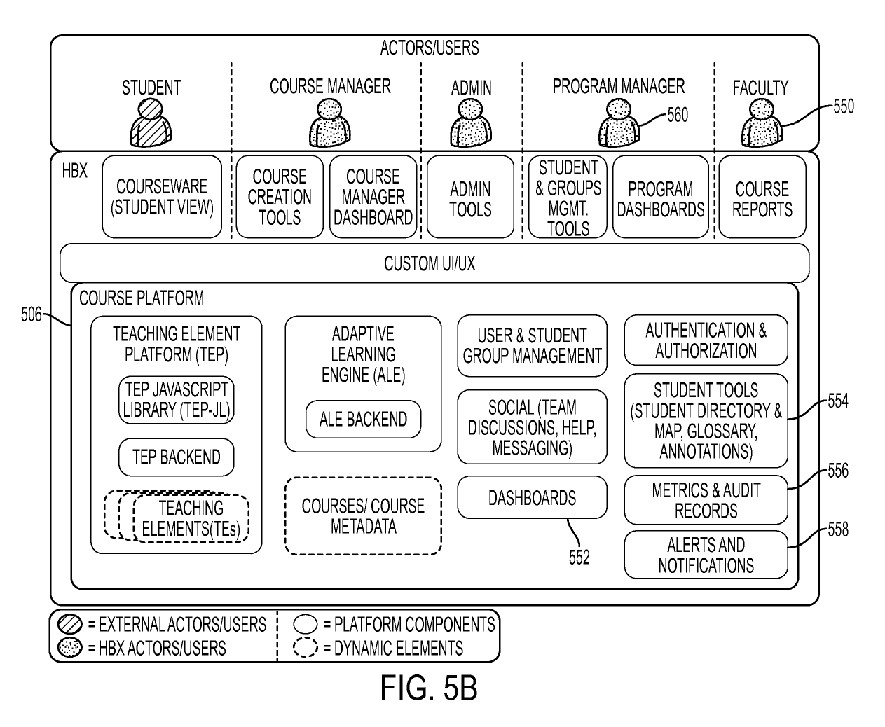

FIG. 5A is a diagram of a logical architecture of the course platform, according to some embodiments of the invention. It shows actors 502 including a student 510, course manager 512, IT Admin 514, Program Manager 516, Corporate Chief Learning Officer (CLO)/Faculty 518 and a UI/UX 504 for each actor. FIG. 5A also shows a course platform 506 including a teaching element platform 532, an adaptive learning engine 534, course metadata 536, user management 538, analytics platform 540, social module 542, localization module 544, authentication module 546, and technical operations support 548.

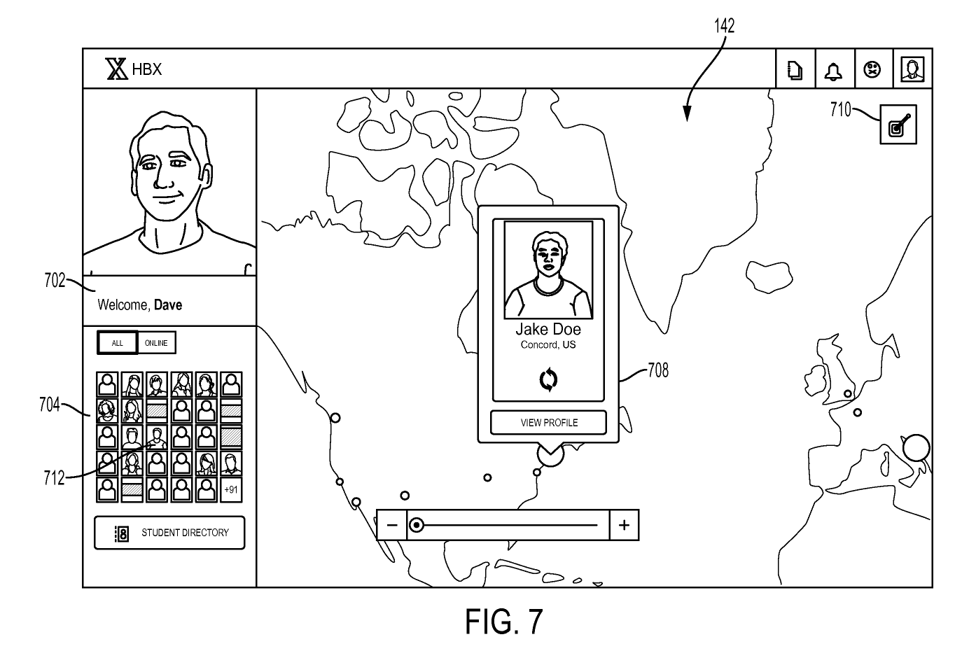

As described in more detail below, the student 510 is the end user for the platform. Briefly, a student 510 interacts with the platform through courseware, as shown in some embodiments in FIGS. 7-24. A student 510 can run courseware on any computerized device (e.g., desktop computer, laptop computer, tablet, mobile phone) and can access the courseware anywhere in the world and at any time of day.

As described above, a course manager 512 creates teaching elements for the platform. A course manager 512 interacts with the platform via a course builder and course manager dashboard. A course manager 512 can use a course builder to define the entire course hierarchy and configure new teaching element instances. A course builder can reuse portions of old teaching elements when applicable, or they can design teaching elements from scratch. Course managers 512, in the design of teaching elements, can configure teaching elements such that they are able to send and receive metadata common to all teaching elements.

IT Admin 514 interacts with the platform through a technical support dashboard. IT Admin 514 monitors the general health of the platform. IT Admin 514 can generate ad hoc reports and send reports to businesses.

Help Desk 516 also interacts with the platform through a technical support dashboard. Help Desk 516 monitors individual experiences on the platform. Similar to IT Admin 514, Help Desk 516 can use metadata from individual users to generate reports. The reports can be used to help students with technical issues.

Faculty/Corporate Learning Officers 518 can interact with the platform through a corporate dashboard. In some embodiments, a company purchases the platform for its employees or third parties. A CLO 518 from the company can monitor the interactions of its employees or third parties with the platform. A facilitator role can allow external representatives such as a Corporate Learning Officer from a client company to view their students and progress.

Course platform 506 runs the logic for each of the actors' tools. Course platform 506 includes a teaching element platform (TEP) 532, an adaptive learning engine 534, course metadata 536, user management 538, analytics platform 540, social module 542, localization module 544, authentication module 546, and technical operations support 548.

TEP 532 includes a TEP Javascript Library (TEP-JSL), a TEP Backend, and teaching elements. The TEP-JSL is the front end of the TEP. The front end provides code to the browser to initiate teaching elements. The TEP-JSL pulls information from the backend, manages the life cycle, manages events and writes states to the backend. The TEP Backend manages the TEP logic. As discussed in more detail below, the backend routes state and teaching element content and metadata to and from the front end and databases.

The adaptive learning engine 534 determines what content to push based on metadata. For example, in a multiple choice question set, a student is presented with a series of questions. The adaptive learning engine 534 can determine a bank of questions associated with the questions presented to the student. The bank of questions can include questions that range in difficulty and topic. When a student answers a series of questions, the adaptive learning engine 534 can evaluate the metadata associated with the question and response. The adaptive learning engine 534 receives the metadata from the analytics platform, which will be described in more detail below. The adaptive learning engine 534 can tailor a series of questions based on the metadata and present another set of questions to the student. The adaptive learning engine 534 can also store the metadata for further evaluation. After gathering metadata from several students, the adaptive learning engine 534 can also tailor questions based on group characteristics.

The course platform 506 also includes a course metadata database 536. Metadata is written and read by the adaptive learning engine 534 as students utilize the course.

The course platform 506 also includes a user registration module 538. The user registration module 538 provides onboarding for users. The user registration module 538 manages the mapping of students, groups and courses. The user registration module 538 can also divide students into cohorts. When students apply for a program, they can apply for a particular instance of a program (e.g. for the June 2014 instance of CORe). The students which get admitted into a particular instance become the cohort for that instance.

The course platform 506 also includes an analytics platform 540. The analytics platform 540 captures metrics around how a student interacts with a platform. The metadata can include time spent on a question, number of tries to answer a question correctly, and other similar metrics. As described above, the analytics platform 540 can send and receive metadata from the adaptive learning engine 534.

The social module 542 includes all social interactions on the platform. The social module 542 encompasses Peer Help 156, One to One messaging 140, as well as discussion groups and group activities (e.g., team exercises 154).

The course platform 506 also includes a localization module 544. The localization module 544 presents the platform content in a language associated with a student's location. For example, a student accessing the platform in China can have the option of receiving platform content in Chinese or English.

The authentication module 546 includes log-in information. The authentication module 546 stores user names and passwords and manages login functions. For example, the authentication module 546 processes changes in passwords or user names.

The technical operations support module 548 helps manage system related issues. For example, the technical operations support module 548 handles failed login attempts, and course progress by user.

FIG. 5B is another diagram of a logical architecture of the course platform, according to some embodiments of the invention. It shows similar elements as FIG. 5A and also shows faculty 550, a program manager 560, a course platform 506 including dashboards 552, student tools 554, metrics and audit records 556, and alerts and notifications 558.

Faculty 550 can interact with the platform through a course reports user interface. The course reports interface allows faculty 550 to obtain student progress and responses. The faculty 550 can use this data to make adjustments to a pre-existing course or to create a plan for a new course.

A Program Manager 560 has the ability to perform account management functions including creating and managing users and student groups, creating announcements, and creating and managing organizations. He or she can also create programs, view the program dashboard as well as student performance and progress reports.

Course platform 506, as described above, can also include dashboards 552. Dashboards 552 are generally used to monitor aspects of the platform including student progress. Dashboards 552 are customizable based on the intended use by each actor. For example, a faculty member can have a dashboard that displays the progress of an entire cohort, while a student can have a dashboard that displays his or own progress broken down by modules and lessons.

Student tools 554 provide students with mechanisms to interact with the platform. Student tools can include a student directory, map, glossary and annotations. As described in more detail below, a student directory allows a student to view names and profile information of other students in the course. A map provides a visual representation of a student directory. A glossary can provide a list of terms related to a student's current course content. The annotations feature allows a student to mark up his or her course pages.

Metrics and audit records 556 is a database containing course metrics. The metrics can be analyzed to monitor and adjust various aspects of the platform. Metrics and audit records 556 can be viewed by actors through a user interface.

Alerts and notifications 558 gives notice to an actor regarding some aspect of his or her courseware. For example, a student can receive a notification about missed messages, new release of course content, or an upcoming deadline. A student can receive announcements related to the platform (e.g. if the system will be unavailable for maintenance) or related to his or her particular course. Also, students can receive and send messages to other students in his or her cohort or members of a team within the cohort.

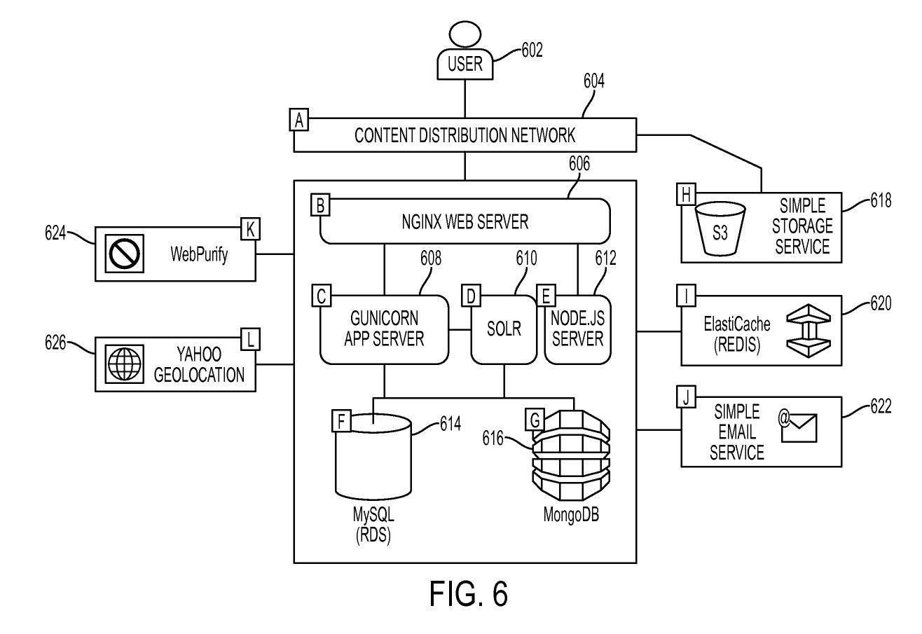

FIG. 6 shows the software architecture for the course platform, according to some embodiments of the invention. It shows a user 602, a content distribution network 604, a web server 606, an application server 608, a search engine 610, an event-driven server 612, a relational database 614, a document-oriented database 616, storage service 618, notification middleware 620, email service 622, profanity filter 624, and geolocation service 626.

As described above, a user 602 can be any actor who interacts with the platform. For example, a user can include a student 510, a course manager 512, an IT Admin 514, Help Desk 516, and CLO 518. A user 602 can send and request content to and from the platform.

A portion of the content from the course platform is delivered to the user 602 by a content distribution network (CDN) 604. A CDN 604 (e.g., Akamai) can be used to accelerate content to end-users. The CDN 604 is used for video delivery and other static assets.

A web server 606 delivers dynamic and static assets to the user 602. Static assets include the HTML and CSS for the structure of the website. Dynamic assets include teaching elements (e.g., media player, quiz, polls). In addition, the web server serves Javascript and CSS (stylesheet) files to client browsers and acts as a reverse proxy server between the user and the application server 608. In some embodiments, the web server is an Nginx server.

An application server 608 is the backend server for the platform. The application server 608 manages a user's session on the platform, handles authentication and authorization logic, and is responsible for storing and retrieving a user's state across the courseware. Generally, the application server 608 executes most of the server-side logic of the application. In some embodiments, the application server is a Gunicorn server running Python.

A search engine 610 facilitates faster searching of the database. In some embodiments, the search engine 610 can be used for a student directory lookup.

The event-driven server 612 provides notification functionality. The notification systems provide real time notifications to the user when there is an incoming message from the system or another student. This can happen in the form of a pop-up message. If the event happens when the student is offline, the message is saved for when the student logs in. When a notification is created (e.g. an announcement), that notification is sent to the middleware service 620. The middleware service then publishes that notification to one or more event-driven servers which are subscribed to the middleware service. Client browsers have network connections open to the event-driven servers and receive notifications as soon as these servers receive them. If a user is not online at the time an applicable notification is sent, he or she will be able to view it when he or she next logs in. The notification from the notification storage is sent to the event-driven server and pushed out to the recipient.

A relational database 614 stores user information. For example, a relational database 614 can store a user's name, password, roles and permissions. The relational database 614 can also store announcement and audit records. In some embodiments, the relational database 614 is MySQL.

A document-oriented database 616 stores courseware, state and metrics information. For example, a document-oriented database 616 can store course versions and metadata associated with student usage of the platform. In some embodiments, the document-oriented database 616 is MongoDB.

A storage service 618 stores and serves static assets. The storage service 618 stores video files (which in turn get cached and delivered to the end user by the CDN), student profile images, and other static content. In some embodiments, the storage service 618 is Amazon S3.

As discussed above, the notification middleware 620 includes a publish-subscribe mechanism to send messages to students. The notification middleware 620 is a publish-subscribe messaging facility which allows new notifications to be quickly delivered to online recipients. It is sent messages by the application server and delivers them to the event-driven server which in turn delivers the messages to end users.

An email service 622 delivers email messages from the platform to users including students and other actors.

A profanity filter 624 is used to screen user-generated content. A course developer can specify which user generated content is screened.

A geolocation service 626 plots the location of a student on a map. For example, the service 626 can receive a student's location and create on an indicator on a map corresponding to the location. The service 626 can accept a location (e.g., city, state, country) and return back coordinates (e.g., latitude and longitude) for a city, state, country. When a user clicks on the indicator, the student's name and profile appears.

FIG. 7 is a screenshot depicting a class directory and a geolocation feature, according to some embodiments of the invention. It shows a student user 702, a cohort of students 704, a map 142 showing the location of students, a student profile 708, and a popup icon 710.

As mentioned above, the platform can be offered to an unlimited number of students. To better simulate a case-study approach to learning, students are divided into smaller groups of cohorts. The platform can include a cohort creation feature that groups enrolled students into cohorts. A cohort can be any number of students and generally ranges from 10-1000 students. A cohort can include a number of students from a variety of geographic locations. Students in a cohort are not only separated by distance and time zones, they can also have different schedules. Some students in the course can be working professionals, while others can be full time students. Some students prefer to work at a consistent pace, while other students prefer to study large amounts of material in one sitting. In some embodiments, the system is designed such that students in a cohort progress through a course at approximately the same time, yet have the flexibility to work according to their own schedule and study habits.

FIG. 7 shows a cohort class directory 704 on a student user's 702 homepage. When a student logs into the course software, an image of the student user is displayed on the homepage. The student image functions as a verification tool, letting the student know he or she has successfully signed into the correct account. The student image can also function as a personalization feature, giving the student a sense of ownership over his or her online course.

Also displayed on the homepage are other members of the cohort 704. Each student that appears in the cohort thumbnail list can also have a corresponding indicator on the map showing his or her location. A student user has the option of viewing all the students in his or her cohort or only the ones presently online. In some embodiments, when a student user hovers over a student image 712 in the cohort list 704, a corresponding student profile 708 appears in the map at the geographic location corresponding to a location given by the student in the student image 712. For example, if a student gives his or location as Los Angeles, Calif., hovering over the student's image can result in the student's profile appearing on the map at a location corresponding to Los Angeles, Calif. Within the student profile 708 is a student's location, name and picture. A student user also has the option of viewing the other student's profile. Profile information can include additional details about the student (e.g., hometown, previous and current occupation, favorite color, dream vacation).

As described above, a map 142 of students can be provided by a geolocation service 626. A geolocation service 626 can receive a student's name and location and plot the student as a colored dot on the map 142. Also as described above, a student's profile information can be stored in a relational database 614. A relational database 614 can store information about group members as well as their relationship to other members in the group.

Course platform pages also include a popup icon 710. The popup icon 710 links to a communication window, as described in more detail below. Briefly, the communication window allows student users to chat in real time, offline, and participate in group discussions.

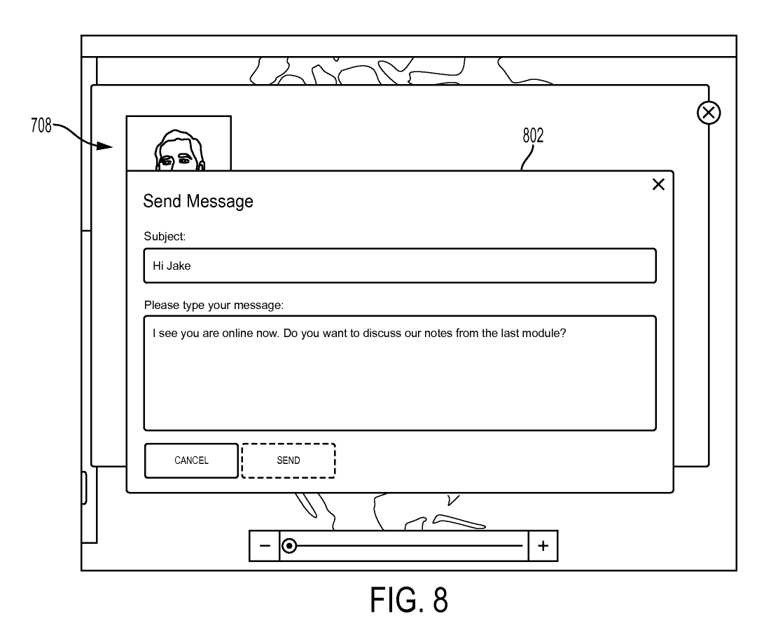

FIG. 8 is a screenshot depicting a One-to-One messaging feature, according to some embodiments of the invention. When a student image appears on the map 142, as shown in FIG. 7, the student user has the option of clicking on the student image 708. In some embodiments, clicking on the student image will open a message box 802. The message box 802 allows the student user to send a private message to another student in the cohort. In some embodiments, a student user can invoke this feature after viewing another student's picture and location. In some embodiments, a student user can invoke this feature after exploring another student's profile.

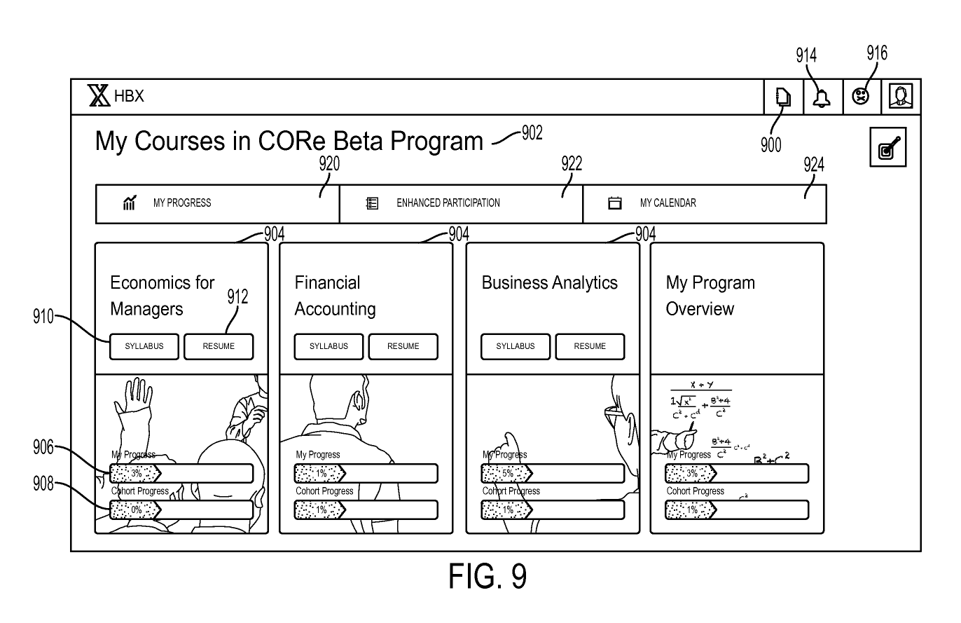

FIG. 9 is a screenshot depicting a student dashboard, according to some embodiments of the invention. It shows a dashboard icon 900, a notification icon 914, an emoticon icon 916, a dashboard 902, a module overview 904, a student user's progress 906, a cohort's progress 908, a syllabus feature 910, a resume feature 912, a progress tab 920, an enhanced participation tab 922, and a calendar tab 924.

In some embodiments, the course platform page includes a header with icons. The icons include a dashboard icon 900, a notification icon 914, and an emoticon icon 916.

A notification icon 914 can indicate a number of system messages for a student user. For example, a notification icon 914 can display a number corresponding to a student user's unread messages. As described above, one of the advantages of the present invention is a student user's ability to interact with other students in his or her cohort. When students in a cohort are online at the same time, students can message, chat or complete exercises with one another in real time. Students who are not online at the same time can also message, chat or complete exercises, albeit not in real time. When a student who is offline receives a message or a chat, the platform can increment a notification count. The student can click on the notification icon to see what chats or messages they received while offline.

An emoticon icon 916 can enable a user to post an emoticon to his or her profile. A student user can choose one of several icons indicating his or her mood (e.g., happy, puzzled, frustrated) at the moment. An emoticon icon 916 is an example of a social feature on the platform that supplements a real-world classroom experience. In a traditional classroom setting, an instructor and a student's peers can often tell through body language and tone of voice how a student feels at any given moment. For example, an instructor can choose not to call on a student whose body language indicates he or she is having a bad day. Students can be more or less critical of a fellow student based on his or her demeanor. The emoticon icon 916 allows a student user to actively project a certain emotion at a given time. For example, a user with a puzzled emoticon can elicit messages from peers offering help.

A dashboard icon 900 can link to a course dashboard page 902. From the course dashboard page 902, a student can navigate to various aspects of a course. For example, a student can view his or her progress in a course 920. As described in more detail below, a student user can view his or her progress overall or by category or module.

A student can also view enhanced participation 922. As described in more detail below, enhanced participation 922 can include interactive features in each of the courses. For example, a fellow student's answer to a question posed by a student user in a prior module can show up in enhanced participation. Other students' responses to a cold call completed by a student user can also show up in enhanced participation 922.

A student can also view a calendar 924. The calendar can display release dates for modules and other course benchmarks.

A course dashboard can also display course overviews 904. The course overviews further comprise a link to a syllabus 910, a resume feature 912, a bar showing my progress 906, and a bar showing cohort progress 908.

The syllabus 910 includes more details about a course 904, including the elements that make up a course. As described in more detail below, a course can be broken down into several layers. For example, a course can contain modules, which can further contain lessons and concepts. An instructor can alter the number and naming convention of course layers. Each of the layers can include teaching elements 210.

The resume feature 912 allows a student to begin a course from a point they most recently stopped. Instead of navigating through a syllabus, a student can use the resume feature as a shortcut to begin where they left off.

The My Progress feature 906 shows a student's current progress. For example, when the My Progress feature 906 shows 3%, it can indicate that a student is 3% of the way through the lesson. Similarly, the Cohort Progress feature 908 shows a cohort's progress. As discussed above, a cohort can comprise a student user and other students progressing through the course in a similar time frame. For example, when the Cohort Progress feature 908 shows 8%, it can indicate that the students in the cohort are, on average, 8% of the way through the lesson. In some embodiments, the Cohort Progress percentage can also represent a sample mean progress or a cohort's median progress.

FIG. 10 is a screenshot showing a detailed view of the My Progress tab on the course dashboard, according to some embodiments of the invention. My Progress tab 920 shows a student's progress displayed by course, and further organized by module 1002, percentage complete 1004, quiz score 1006 and help questions and answers counter 1008.

As discussed above, courses can include modules. Modules divide course material up into additional categories. For each module, a percentage complete is displayed 1004. The percentage complete shown for each module represents the amount a student's progress in a given module. For example, 37% complete indicates that a student is 37% finished with a module.

In some embodiments, there can be a quiz 1006 associated with a module. When a module includes a quiz, the My Progress Page can display a percentage corresponding to a student user's quiz score. For example, 75% can indicate that a student answered 75% of the questions correctly.

In some embodiments, there can be a help questions and answers counter 1008. As described in more detail below, for each concept section, a student has the option of asking a question. When a student asks a question, the help question counter 1008 can increment. For example, when a student asks 2 questions in concept section 1 of module 1, and 3 questions in concept section 1 of module 1, the help question counter 1008 for module 1 is 5. Similarly, for questions answered, the help answers counter 1008 reflects the number of questions a student user answers in a module.

FIG. 11 is a screenshot showing a view of a syllabus, according to some embodiments of the invention. It shows a syllabus page 1102 including a percentage completion indicator 1104, lessons 1106 1108 1110, and concept pages 1112.

A syllabus page 1102 includes various elements in a course. The syllabus page 1102 includes a percentage completion indicator 1104 similar to one in the My Progress Tab. The percentage shown can represent a student's progress through a module.

A syllabus page 1102 can also include links to lessons 1106 1108 1110 within the module. A highlighted lesson indicator 1106 corresponds to the concept pages 1112 shown on the syllabus page 1102. For example, the concept pages 1112 shown at the bottom of FIG. 11 correspond to a lesson on Willingness to Pay 1106, which is highlighted at the top of FIG. 11. In some embodiments, the concept pages 1112 are further breakdowns of the lessons. A non-highlighted lesson with a corner folded 1108 can indicate a lesson that is accessible by the user but not currently selected. A user can click on a non-highlighted lesson and display the concept pages associated with the lesson. A non-highlighted lesson with a lock icon 1114 can indicate a lesson that has not yet been unlocked. As described above, a lesson can remain locked when a user has not completed a required exercise in the previous lesson. A lesson can also remain locked when a setting in the platform indicate that a lesson should not be released yet.

The concept pages 1112 can represent individual concepts within a module. Each concept page can include a number of teaching elements. Each concept icon provides a link to a corresponding concept page.

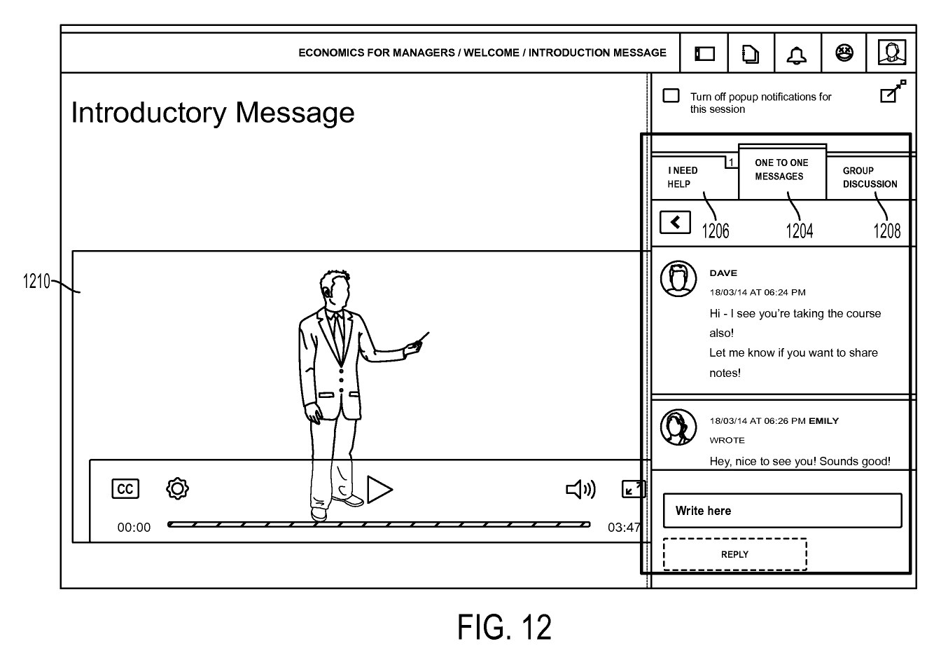

FIG. 12 is a screenshot showing an example of One-to-One messages in a communication window, according to some embodiments of the invention.

As mentioned above, a communication window facilitates student communication that is linked to a student's course progression. The communication window includes communication based on a state-based loosely-synchronous learning model. A state-based loosely-synchronous (SBLS) learning model includes both synchronous and asynchronous elements. The SBLS learning model is asynchronous because students can log onto the platform at any time and progress through the course at their own pace. Students can log into the platform and access material 24 hours a day from anywhere in the world. Students, for the most part, can also watch lectures and complete exercises at their leisure. The synchronous element of the SBLS learning model is a gating feature that includes system imposed rules, individual proficiency, and student choice. System imposed rules include module release dates. For example, a student can work at his or her own pace through released modules. An instructor can choose to design a course that releases a module every week or two weeks. If a student finishes a module within a day, he or she would have to wait until the next week to start the next module. A student's proficiency can also act as a gating function. Within a course, an instructor can designate a level of student proficiency to be achieved before moving on to the next element. For example, a student can be forced to stay on one concept until he or she answers a number of questions correctly in a question set. A student can also be gated based on his or her own choices. For example, if a student chooses to work quickly through each module of the course, the platform can group the student together with other students who work in a similar fashion. As discussed in more detail below, a module can remained locked until a group activity is completed.

FIG. 12 shows a communication window including an I Need Help feature 1206, a One to One Messages feature 1204, and a group discussion feature 1208. FIG. 12 also shows a video lecture 1210.

One aspect of the communication window is One to One Messages 1204, which allows a user to communicate directly with another student in a cohort. A student can see whether a student is online at the moment of communication. When both a student and a student user are online, the One to One Messages 1204 functions similarly to an instant messaging service. When the intended recipient is offline, One to One Messages 1204 functions similarly to an email client.

In some embodiments, the messages can be tagged to the content show in the adjacent window. For example, in FIG. 12, the comments made in the One to One Messages 1204 are tagged with the video lecture 1210.

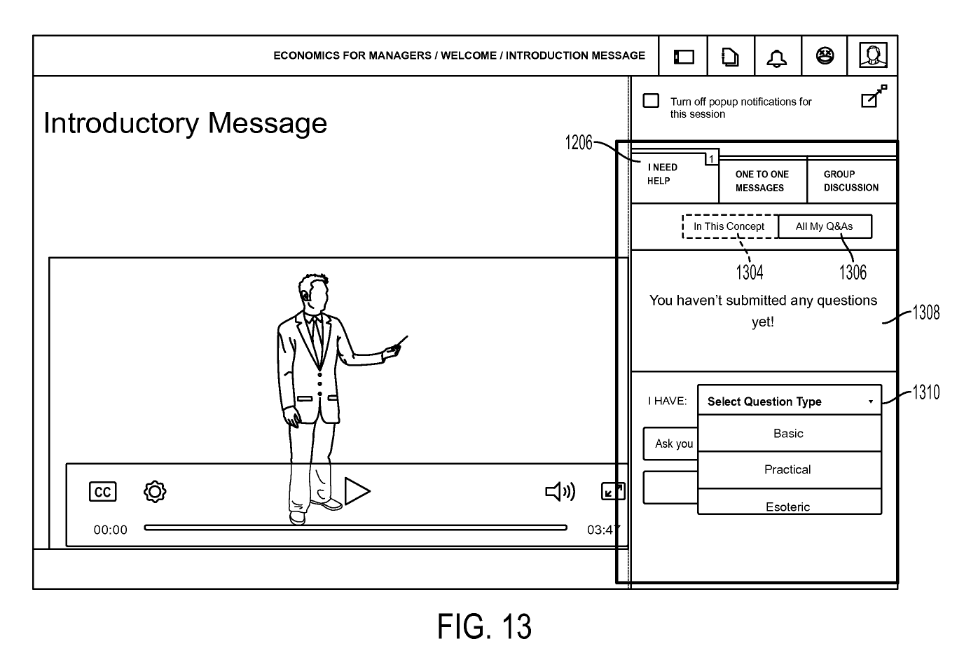

FIG. 13 is a screenshot showing an I Need Help Feature, according to some embodiments of the invention. It shows an I Need Help Feature 1206 including a In This Concept feature 1304, All My Q&As feature 1306, a display area 1308 and a question type drop down 1310.

As described above, a communication window can include an I Need Help feature 1206. In some embodiments, an I Need Help feature 1206 allows a student user to submit a question to a cohort regarding a particular teaching element or concept. In some embodiments, only students who have reached the same point in the course can post an answer. For example, when a student has a question about one portion of a video, the student can post a question in the I Need Help feature 1206. Only students in the cohort who have also started watching the video can answer the student user's question. Questions and answers can be displayed in a display area 1308. The display area 1308 can also indicate that no questions have been asked yet. Students can provide a utility ranking to a question, answering the question “how useful is this question” by selecting one response e.g. very, somewhat, not particularly. When a response to a question is submitted by a student, peers can select one or more social qualifiers for the response (e.g., well-written, brilliant, Laugh Out Loud (LOL), practical). Social qualifiers can be set for the specific program and are configurable. Both the utility rankings and social qualifiers allow the system to highlight the most relevant and helpful student questions and answers.

The I Need Help feature 1206 also includes an In This Concept feature 1304 and an All My Q&As feature 1306. When a user selects the In This Concept feature 1304, only questions and answers related to a particular concept are shown. For example, when a user is working through teaching elements related to Concept A, questions and answers related to Concept A are shown in the display area 1308. When a user selects the All My Q&As feature, all questions posed by the user, and the accompanying answers can be displayed in the display area 1308.

The I Need Help feature 1206 also includes a question type drop down 1310. A question type drop down can include categories of questions (e.g., basic, practical, esoteric). As discussed above, the platform encourages social interaction among its participants. In a traditional classroom setting, students can filter their questions to their peers based on setting, tone of voice, or express disclaimers. Students can choose to preface their questions and ask questions accordingly in the appropriate situations. For example, a classroom setting can incentivize a student to ask serious questions, while a conversation in the hallways can result in esoteric questions. The question type drop down 1310 provides a similar filtering effect for students using the platform. The question type drop down 1310 incentivizes students to ask questions by giving them the freedom to ask basic or esoteric conversations. By allowing students to preface that a question is basic or esoteric, the platform provides students a discussion platform that can be less judgmental.

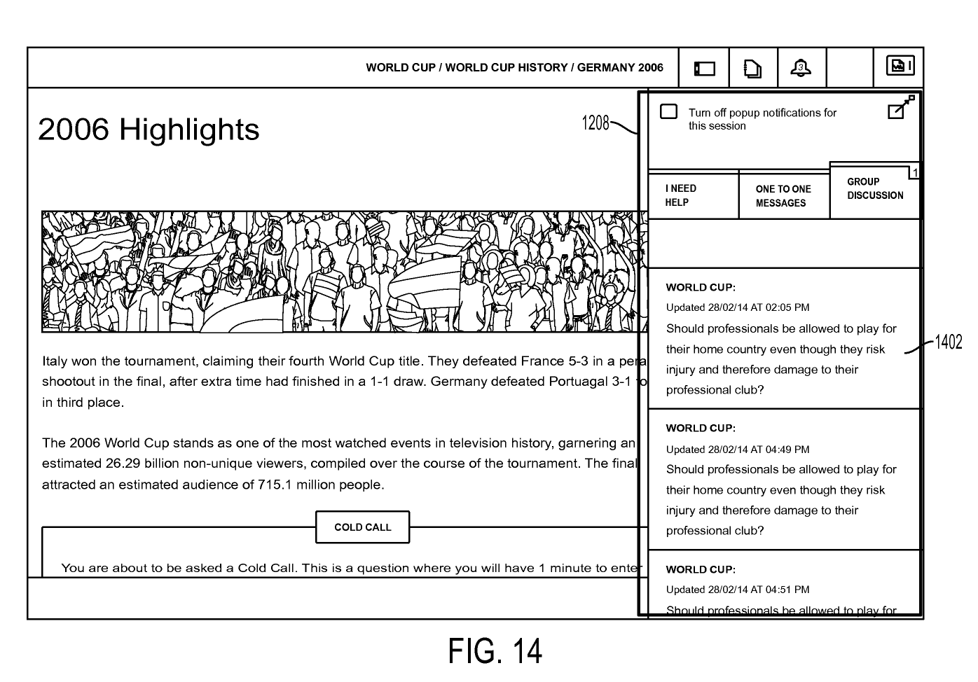

FIG. 14 is a screenshot showing a group discussion feature, according to some embodiments of the invention. It shows a group discussion feature 1208 including group discussion topics 1402.

As discussed above, the platform includes state-based loosely-synchronous (SBLS) learning. One element of SBLS learning is to encourage students at a similar point in a course to work in groups. In some embodiments, a group discussion can be triggered by reaching a certain point in a course. For example, a group discussion can occur at a trigger point. As discussed in more detail below, a trigger point can be embedded at any point within a course. Briefly, a trigger point can initiate a teaching element. For example, a trigger point can be embedded within a video. When a student reaches a certain point in the video, the trigger point initiates a teaching element (e.g., a cold call, poll, multiple choice). In some embodiments, the video does not continue until a student finishes the teaching element initiated by the trigger point. In some embodiments, the teaching element initiated by a trigger point can be a group discussion 1208. The platform can be configured to allow a certain number of students (e.g., 4 to 10 students) in a group discussion. In some embodiments, students can be assigned to a group once they reach a certain point in the course. Once a group is full, the platform will form another group. For example, when a group is configured to have six individuals, the first six to reach a designated point in a course are assigned to a first group. The seventh person to arrive at the designated point in the course is assigned to a second group.

In the group discussion window 1208, group discussion topics can be displayed as they become applicable to a student (e.g., when the student reaches a designated point in the course). For example, a group discussion can be set as a trigger point after a cold call. As discussed in more detail below, a cold call is a timed question. Briefly, the cold call can be placed as a trigger point anywhere in the course. Once a student accepts a cold call, the student has a certain amount of time to answer a question. Once the student answers the cold call question, the cold call question can be a topic for group discussion.

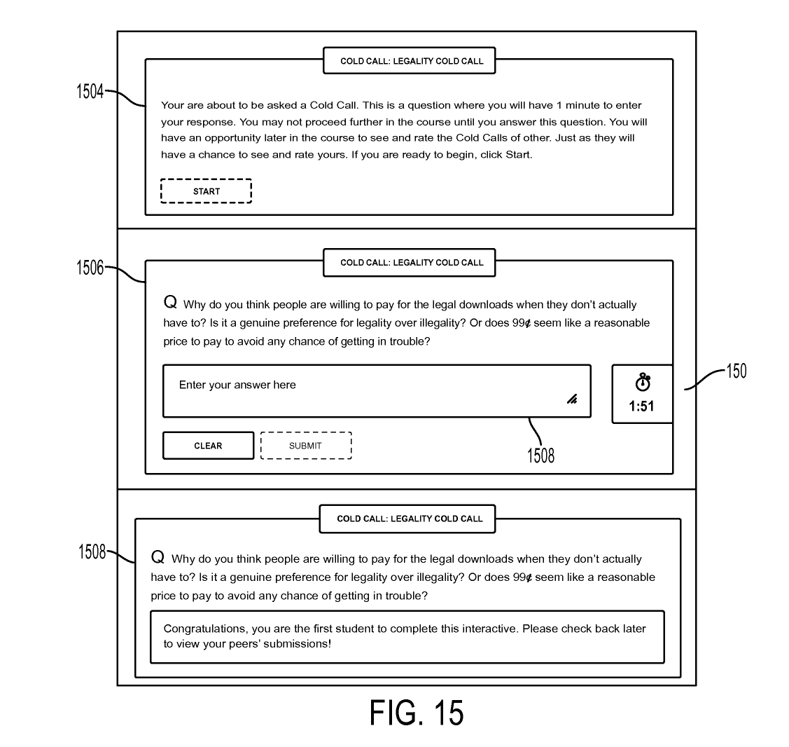

FIG. 15 is a screenshot showing a cold call, according to some embodiments of the invention.

A cold call 150 is one type of teaching element. In a traditional classroom, a cold call keeps students alert because the students do not know when and what question will be asked. A cold call promotes student engagement through anticipation.

On the platform, a cold call 150 is similar to a cold call in a traditional classroom. A student does not know when in the course he or she will be offered a cold call 150. A student also does not know what question will be asked. The platform cold call 150 is also, in some aspects, more effective than a cold call in a classroom. As discussed in more detail below, a cold call 150 can be offered to every student taking the course. Often in a traditional classroom, an instructor can only cold call one student. Additionally, the platform can monitor metrics of a cold call 150. The platform can analyze how long a student spent on a cold call, the substance of the cold call response, and response from a student's peers to his or her cold call response. The platform can use these metrics to generate reports. The reports can inform course developers and instructs about effective or ineffective design and placement of content.

An instructor can insert a cold call 150 as a trigger point anywhere in a course or concept page. An instructor can also choose several locations in a concept page to insert a cold call 150. For each trigger point, the instructor can link a cold call question. A cold call 150 can randomly be served up to a student at any of the trigger points. For example, an instructor can choose to insert three cold call trigger points within one teaching element (e.g., a video). The instructor can also link three distinct cold call questions to each of the three trigger points. When a student progresses through the teaching element, one of the three cold calls can be randomly served to the student. If there are 90 students in the student's cohort, roughly one third of the students are served a cold call question at the first trigger point, roughly one third of the students are served a cold call question at the second trigger point, and roughly one third of the students are served a cold call question at the third trigger point. Randomizing the cold call location and question on the platform keeps the element of surprise in a cold call. If the same cold call question were served in the same location for every student in a cohort, a student who progressed through a course at a faster pace than others in his cohort could ruin the effect of a cold call by posting the exact location and question for the cold call.

As shown in FIG. 15, a cold call 150 includes a warning 1504, a question 1506, a response area 1508, and a peer submission area 1508.

When a student reaches a cold call trigger point in a course, the student first receives a warning 1504. The warning informs the student that he or she is about to receive a cold call. Once the student accepts the cold call, the question 1506 is presented. The student cannot proceed in the course until he or she answers the cold call.

After the student is shown the cold call question 1506, he or she has a certain amount of time to enter a response in the response area 1508. If the student does not submit the answer in the allotted time, the platform can automatically submit the text in the response area 1508.

Once the response is submitted, the user is shown a peer submission area 1508. A user can view other students' responses, provided the other students reached this point before the user.

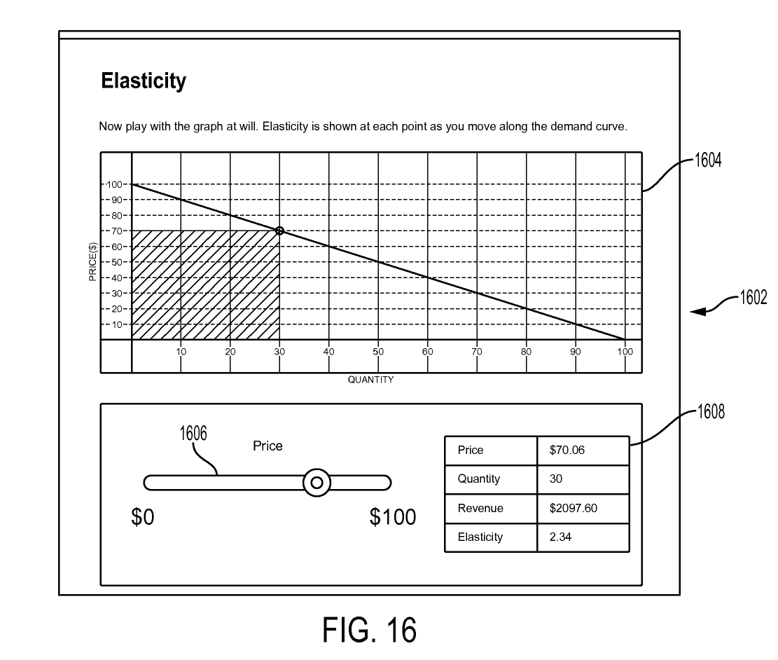

FIG. 16 is a screenshot depicting a course specific teaching element, according to some embodiments of the invention. It shows an elasticity intuition builder 1602, including a demand curve 1604, a price slider 1606 and a variable display 1608.

Course specific teaching elements are teaching elements that are intended for a particular course on the platform. For example, a teaching element directed at price elasticity can have limited use outside an economics course. As described in more detail below, course developers can create teaching elements that are specific to a course. The course specific teaching elements can be stored in a library and used by instructor teaching a similar course in the future.

Teaching elements can have a certain amount of standard metrics. As described below, the standardization of metric gathering in teaching elements provides for the easy porting of teaching elements from one course to another.

One type of teaching element is an intuition builder. An intuition builder allows a user to interact with a concept. There is no right answer attached to an intuition builder. For an elasticity intuition builder 1602, a user can interact with the intuition builder in a couple of ways. A user can move an indicator on the demand curve 1604. A user can also adjust an indicator on a price slider 1606. Adjusting either the demand curve 1604 or the price slider 1606 results in changes in the variable display. A student can play with the graph to develop an intuition as to how elasticity relates to price, quantity and revenue.

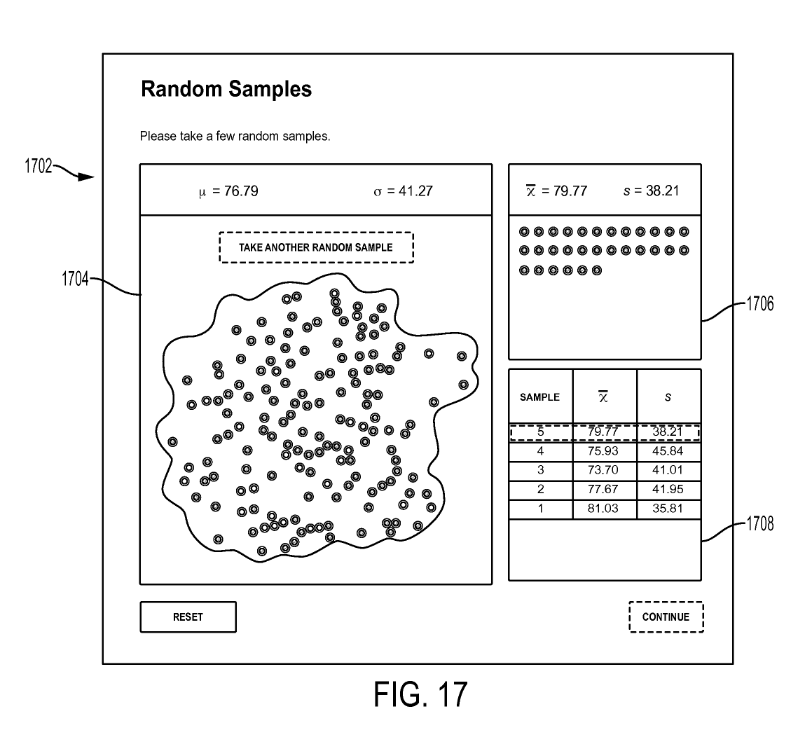

FIG. 17 is a screenshot showing another course specific teaching element, according to some embodiments of the invention. It shows a random samples intuition builder 1702, including a random sample pool 1704, sample window 1706, and a list of random samples 1708.

As described above, intuition builders are not focused on having students get the right answer. An intuition builder allows a user to interact with a concept. A random samples intuition builder 1702 is an example of a course specific teaching element used in a business analytics class, for example. For a random samples intuition builder 1702, a user can explore the difference between an arithmetic mean and standard deviation and a sample mean and standard deviation. A user can initiate a random sample, and a subset of dots from a random sample pool 1704 moves to a sample window 1706. At the same time, the sampled mean and standard deviation are logged in a list of random samples 1708. A user can take several samples, and each sample's mean and standard deviation can be logged in the list of random samples. The user can develop an intuition about population sample versus arithmetic sample by taking various samples.

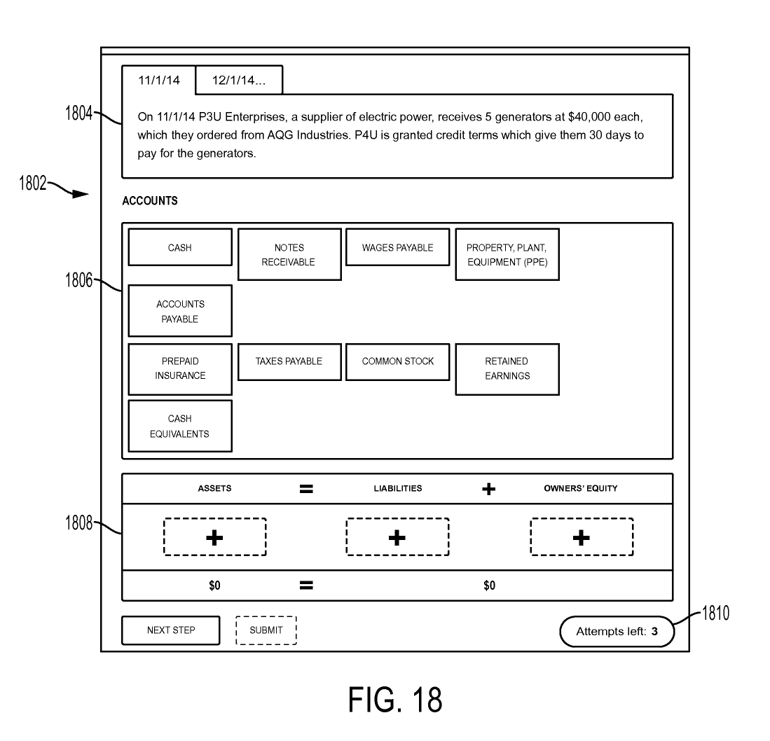

FIG. 18 is a screenshot showing another course specific teaching element, according to some embodiments of the invention. It shows an accounting equation teaching element 1802, including prompts 1804, modules 1806, an equation space 1808, and a number of attempts 1810.

Unlike intuition builders, some teaching elements include a right and wrong answer. An accounting equation teaching element 1802 is an example of teaching element that includes a right or wrong answer. A user is presented with a prompt 1804. In some embodiments, the prompt can include a date. The date can represent an unlocking date for the prompt. The prompt can also include tabs with later dates, wherein the tabs including later dates are not unlocked until a given date.

Based on the prompt 1804, a user can select a module 1806 to drag and drop the module into the equation space 1808. When a user is satisfied with his or her answer in the equation space, the user can submit the answer. A user can also be shown a number of attempts 1810. The number of attempts 1810 can indicate how many submissions a user has to get the right answer. In some embodiments, if the user does not get the right answer in the allotted attempts, a user can be presented with additional exercises.

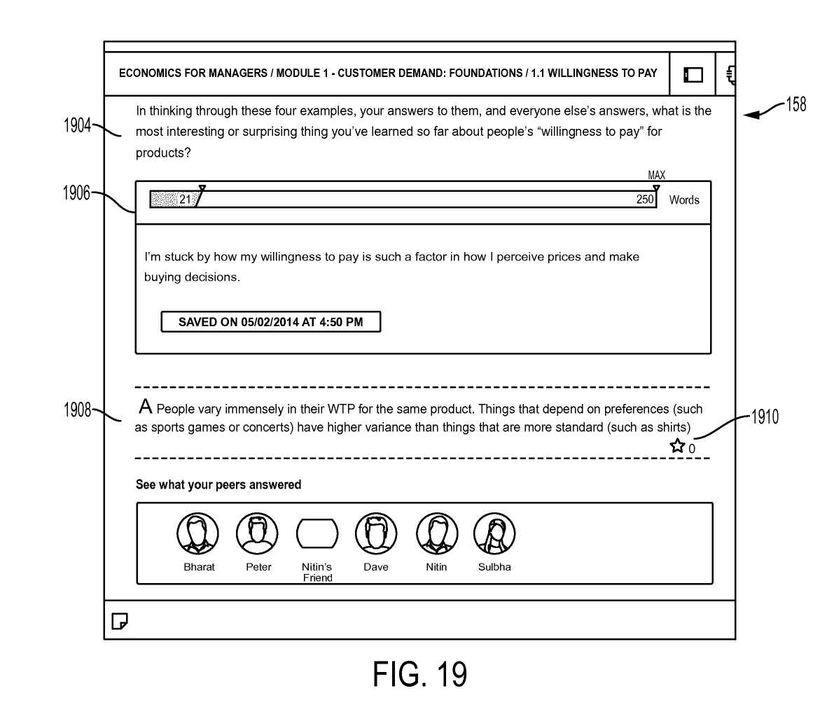

FIG. 19 is a screenshot showing a shared reflection, according to some embodiments of the invention. It shows a shared reflection 158, including a prompt 1904, an input area 1906, a response display area 1908, and rating feature 1910.

Shared reflection 158 is one of the social and active aspects built into the platform. Shared reflection 158 is one type of teaching element. Similar to other teaching elements, shared reflection 158 can be initiated based on a trigger point.

When a shared reflection 158 is initiated, the user is presented with a prompt 1904. The user can enter a response to the prompt in the input area 1906. After the user enters a response, the user can view responses in a response display area 1908 posted by other users in the same cohort. A user can be prevented from viewing other user posts until he or she enters a response. The user also has an option of giving a rating 1910 to a response. For example, when a user agrees or likes a response, he or she can give the response a rating (e.g., a star, a numerical value, a thumbs-up).

The platform can also perform semantic analysis on a user's response. The results of the analysis can be stored as metadata or used to guide group discussions. For example, in a traditional case-study approach classroom, an instructor can pose a controversial question and solicit several responses from students. The instructor can choose to start a debate between two students whose responses are at the farthest ends of a spectrum from one another. The instructor can choose to start a debate between the two students to pull out ideas for the rest of the class to consider. Similarly, on the platform, semantic analysis can be used to determine which student responses are the most diametrically opposed to one another. For example, the platform can be programmed to pick up words indicating strength of position (e.g., really, greatly, strongly) and combine them with a particular position (e.g., yes versus no, hate versus love, agree versus disagree). The platform can choose to start a debate between students who appear to be the farthest apart on the issue. The platform can limit the conversation to only the two students, or prevent others from entering the conversation for an amount of time (e.g., 5 minutes or one day). Similar to a traditional classroom, other students on the platform can read the transcript of the debate and learn from the discussion of their peers.

In some embodiments, a user's response can be a shared photo 152. As discussed above, a shared photo can be both active and social. A student's shared photo 152 can be active because it can be an action required by the platform to advance to the next section. A student's shared photo 152 can also be social. As in the student profiles, discussed in FIG. 2, a student's shared photo 152 can include information about an individual and their experiences. For example, a student can be prompted by the platform to share a photo 152 of a price inelastic element. A student in the United States may post a picture of a gallon of milk, while a student in China may post a picture of a bag of rice. By facilitating the sharing of photos, students can learn from their peers how concepts can have different meanings depending on a person's location and experiences.

As discussed above, a student's grade partially depends on his or her participation in class. The platform further incentivizes student response by rewarding students to interact with their peers. Linking a student's grade to online participation incentivizes a student to leave comment or rating for another student's response. An example of a rating in FIG. 19 is leaving a star 1910. A student can leave a star if they like another student's comment.

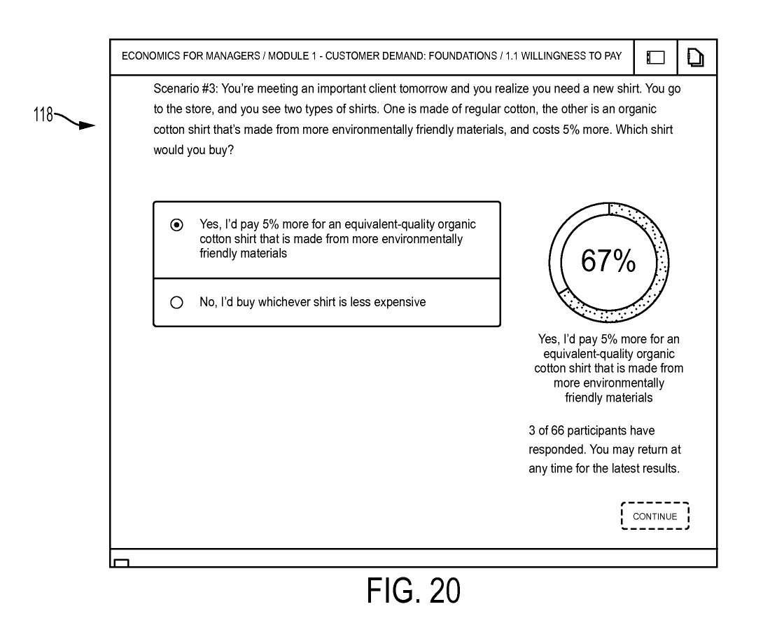

FIG. 20 is a screenshot showing a poll, according to some embodiments of the invention.

A poll 118 is another type of teaching element. As with other teaching elements, a poll 118 can be inserted sequentially as a teaching element or initiated by a trigger point. Within the context of a case discussion, students are posed questions on what they would do in various scenarios. They are then shown how the rest of their cohort responded. Similar to share a photo 152, a poll 118 provides a student with a sense of how his or her peers think about a concept.

A poll 118 can be served more than once in a course. Later in a course via a “Before & After” Teaching Element, students are shown the question and updated totals again and asked how their thinking had changed as they progressed through the case. A poll 118 can also be used to guide group discussion, as described above for shared reflections. The platform can take poll responses at opposite ends of a spectrum to generate a debate. For example, if a poll 118 offers answers from 1 to 10 ranging from strongly disagree to strongly agree, the platform can take two students who answered 1 and 10, respectively, to start a debate.

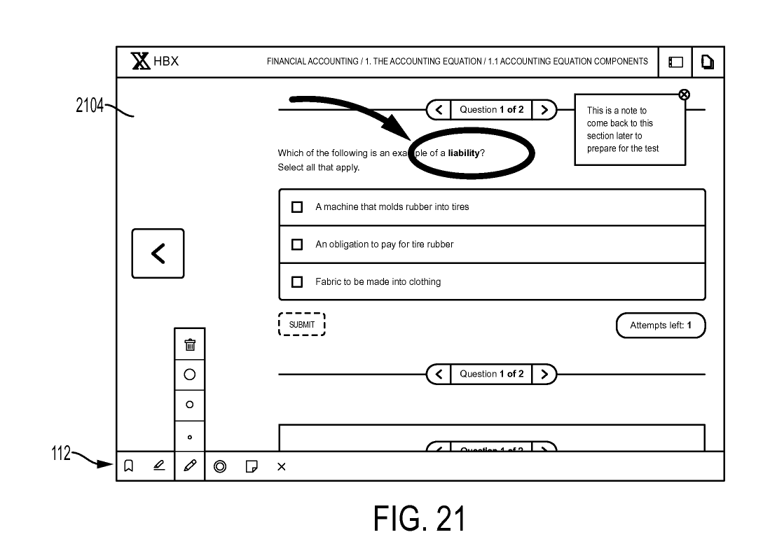

FIG. 21 is a screenshot showing an example of courseware tools, according to some embodiments of the invention. It shows annotation tools 112 and student annotations 2104.

Analogous to a paper printout of a case for a student to make annotations, the system provides tools for the student to mark and save the content on their courseware pages by highlighting, drawing, and annotating and quickly filtering their syllabus view to see these enhanced pages. From the annotation tools 112, students can choose a method of annotation (e.g., bookmark, draw, sticky note). The students can use tools from the toolbar to mark up a course page 2104.

Annotations made on course pages also appear on the syllabus. Students can view in the syllabus which pages contain annotations.

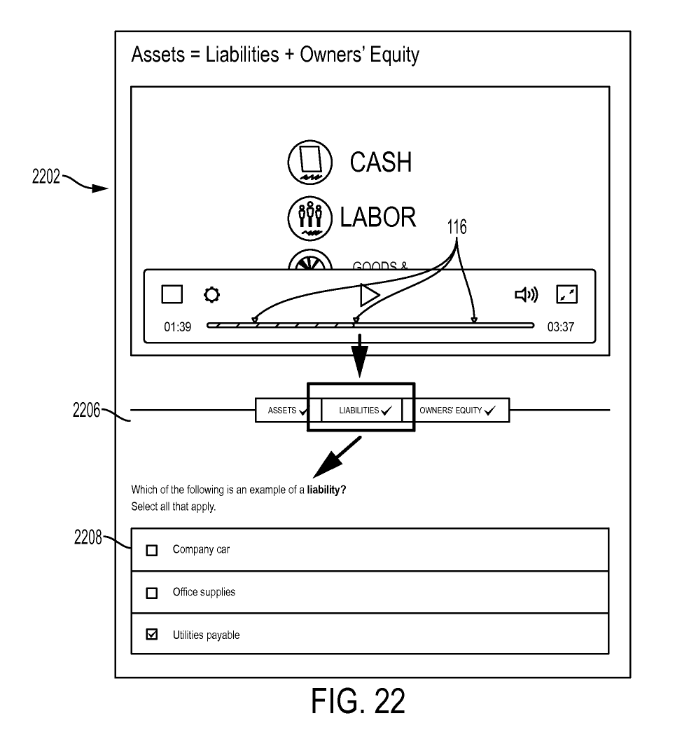

FIG. 22 is a screenshot showing an example of a trigger point, according to some embodiments of the invention. It shows a video teaching element 2202, including three trigger points 116, three trigger point topics 2206, and questions 2208.

In a case based approach, professors intersperse interactive exercises at strategic points in the lecture. For example, the professor can cold call a student, initiate a student debate, or ask the class a question that reinforces an important topic.

On the platform, an instructor can use trigger points 116 as interactive insertions at strategic points in the lecture. The trigger points 116 can be placed anywhere in a video lecture. When a trigger point 116 is reached, a corresponding trigger point topic bar 2206 is accessible. The trigger point topic bar 2206 can have a separate topic for each trigger point 116. Once a trigger point 116 is reached, a topic is unlocked. The student has to answer a question 2208 associated with the question before proceeding with the lecture. Once a student passes a trigger point 116, the student can rewind and come back to the trigger point 116 at any point. A student cannot fast forward through the video until all trigger points 116 have been completed.

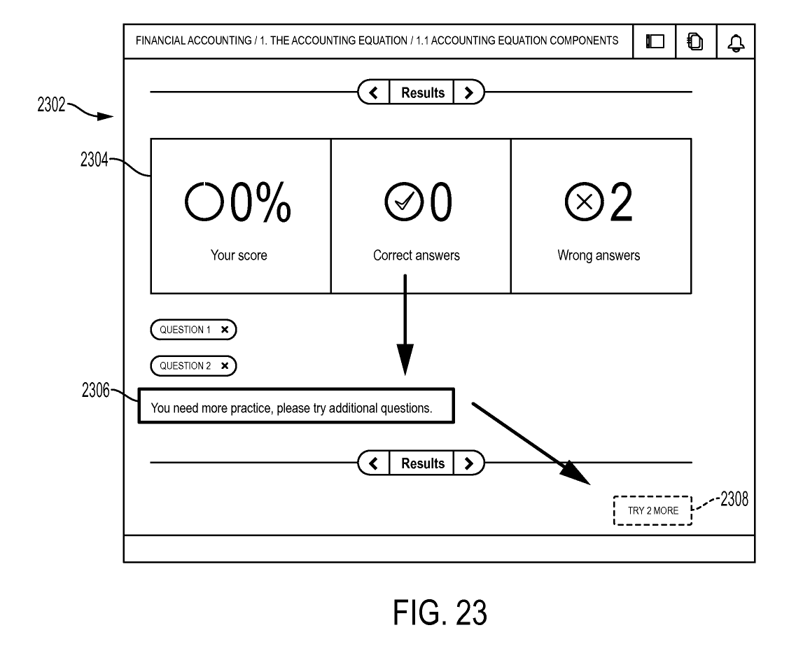

FIG. 23 is a screenshot showing an example of multiple choice, according to some embodiments of the invention.

In a traditional classroom, an instructor can ask a question of the entire class. An instructor can also solicit more than one answer for his or her question. In a case study approach, an instructor can choose to develop a conversation of a student's answer that lines up most closely with an instructor's desired answer. An instructor can also ask a series of questions to a student who answered incorrectly. By asking a student questions that takes a student's answer to a logical conclusion, a student can not only realize the answer was wrong, but why it was wrong.

The multiple choice feature 2302 in the platform provides an iterative experience, as a student has in a traditional classroom. Multiple choice 2302 is one type of teaching element, and as discussed above, can be placed anywhere in the course.

In some embodiments, after a student finishes a multiple choice section, the number of correct answers and wrong answers are shown 2304. A course instructor can choose how many questions a student needs to answer correctly before the student can proceed to the next section. If the student does not answer a threshold number of questions, the student is instructed to try additional questions 2306. In some embodiments, a student cannot move forward in the course until the student elects to complete another question set 2308.

Additional question sets can use analytics gathered in a previous question set. For example, if a user misses questions specifically in one concept, the next question set can include questions only from that concept. If the student misses every question, the next question set can include easier questions first.

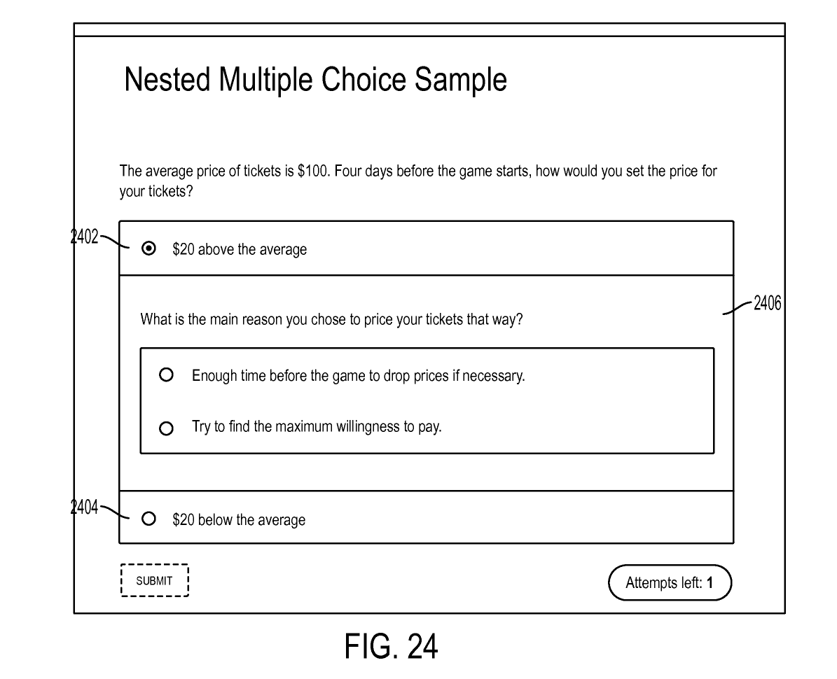

FIG. 24 is a screenshot showing an example of nested multiple choice, according to some embodiments of the invention. It shows a first answer choice 2402, a second answer choice 2404, and a follow up question 2406.

As discussed above, in a case study approach, an instructor can choose to develop a conversation of a student's answer that lines up most closely with an instructor's desired answer. An instructor can also ask a series of questions to a student who answered incorrectly. By asking a student questions that takes a student's answer to a logical conclusion, a student can not only realize the answer was wrong, but why it was wrong.

The platform can provide a nested multiple choice to simulate a series of questions a professor can ask in class. A student can be presented with a question that has a first answer choice 2402 and a second answer choice 2404. When the student chooses one of the answer choices, another set of questions can appear. For example, when a student chooses the first answer choice 2402, a follow up question 2406 appears. Based on a student's response to the follow up question 2406, another follow up question can appear. A series of follow up questions can follow a decision tree format and eventually lead the student to a conclusion. The conclusion can show a student either why they answered a question correctly, or why they answered a question incorrectly.

Preferred embodiments of the invention provide content selection and scheduling logic to release content based on a defined schedule. As described above, a student can progress through a course independently, but can be gated at certain points based on defined release dates of course content. Content selection and scheduling logic can also influence a student's progression through course content based on responses from other students. Conditioning a student's progression through a course based on the actions of his or her peer students emulates a physical case-study classroom, in which course content and student responses are critical to learning.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of nonvolatile memory, including by way of example semiconductor memory devices, (e.g., EPROM, EEPROM, and flash memory devices); magnetic disks, (e.g., internal hard disks or removable disks); magneto optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The subject matter described herein can be implemented in a computing system that includes a back end component (e.g., a data server), a middleware component (e.g., an application server), or a front end component (e.g., a client computer having a graphical user interface or a web browser through which a user can interact with an implementation of the subject matter described herein), or any combination of such back end, middleware, and front end components. The components of the system can be interconnected by any form or medium of digital data communication, e.g., a communication network. Examples of communication networks include a local area network (“LAN”) and a wide area network (“WAN”), e.g., the Internet.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the invention has been made only by way of example, and that numerous changes in the details of implementation of the disclosed subject matter may be made without departing from the spirit and scope of the disclosed subject matter, which is limited only by the claims which follow.

What is claimed is:

1. A system configured to offer to a large pool of students a loosely synchronous online course that facilitates student interactions and behavior to emulate a physical case-study classroom, in which course content and student responses are critical to learning, the system comprising:
a user registration module, configured to divide the large pool of students into cohorts of a smaller number of students, each cohort being a subset of the students;
course content stored in a computer-readable storage medium, the content being divided into lessons and the content comprising combinations of social, passive, active and adaptive teaching elements and in which the teaching elements include computer rules and logic to specify synchronization points at which students within a cohort are to interact among one another or at which students within a cohort synchronize their individual progression through the course content; and
content selection and scheduling logic that releases lesson content according to a defined schedule so that an individual student may progress through a course relatively independently and at his or her own pace but which prohibits a student from progressing to a subsequent lesson until a defined release date for that lesson so that students with a cohort will synchronize their progress through the course at least at the defined release dates, and that selects content within a lesson in response to an interaction by the student with the content and with other students, so that interactions of a cohort with the content in a lesson influences the selection of subsequent content for the lesson, and in which interactions of a student with the stored content becomes student derived content to be shared with the cohort, such that each student progresses through the course relatively independently and is loosely synchronized at defined points with other students in the same cohort in a manner that emulates student interaction in a physical case-study classroom.

2. The system of claim 1, wherein a passive teaching element comprises logic to deliver media to a student.

3. The system of claim 1, wherein a social teaching element comprises logic to provide for student interaction with the cohort in response to a combination of the stored content and the student derived content.

4. The system of claim 1, wherein an active teaching element comprises logic to provide for student interaction with the stored content such that the student responds to the stored content.

5. The system of claim 1, wherein an adaptive teaching element comprises logic to analyze a prior response of an individual student and to provide stored content conditioned on the prior response of the individual student to help the student learn from his or her own responses.

6. The system of claim 1, further wherein the content selection logic selects two or more students in a cohort for further interaction based on the student derived content.

7. The system of claim 6, further wherein the content selection logic selects the two or more users based on a semantic analysis of the student derived content such that the two or more students are selected based on opposing viewpoints expressed through the responses of the two or more students.

8. The system of claim 6, wherein the further interaction comprises a defined point where students in a cohort are loosely synchronized.

9. The system of claim 1, wherein the student derived content is a student response received based on a trigger point within a teaching element, the trigger point comprising an insertion point at a designated time within a teaching element where additional content is delivered.

10. The system of claim 9, wherein the trigger point is one of two or more trigger points, wherein each trigger point is associated with different content, and the content selection logic randomly chooses the trigger point and corresponding content to serve to the student.

11. A method of offering to a large pool of students a loosely synchronous online course that facilitates student interactions and behavior to emulate a physical case-study classroom, in which course content and student responses are critical to learning, the method comprising:
dividing, by a computing device, the large pool of students into cohorts of a smaller number of students, each cohort being a subset of the students;
dividing, by the computing device, course content into lessons, the content comprising combinations of social, passive, active and adaptive teaching elements and in which the teaching elements include computer rules and logic to specify synchronization points at which students within a cohort are to interact among one another or at which students within a cohort synchronize their individual progression through the course content;
releasing, by the computing device, lesson content according to a defined schedule so that an individual student may progress through a course relatively independently and at his or her own pace but which prohibits a student from progressing to a subsequent lesson until a defined release date for that lesson so that students with a cohort will synchronize their progress through the course at least at the defined release dates; and
selecting, by the computing device, content within a lesson in response to an interaction by the student with the content and with other students, so that interactions of a cohort with the content in a lesson influences the selection of subsequent content for the lesson, and in which interactions of a student with the stored content becomes student derived content to be shared with the cohort, such that each student progresses through the course relatively independently and is loosely synchronized at defined points with other students in the same cohort in a manner that emulates student interaction in a physical case-study classroom.

12. The method of claim 11, wherein a passive teaching element comprises logic to deliver media to a student.

13. The method of claim 11, wherein a social teaching element comprises logic to provide for student interaction with the cohort in response to a combination of the stored content and the student derived content.

14. The method of claim 11, wherein an active teaching element comprises logic to provide for student interaction with the stored content such that the student responds to the stored content.

15. The method of claim 11, wherein an adaptive teaching element comprises logic to analyze a prior response of an individual student and to provide stored content conditioned on the prior response of the individual student to help the student learn from his or her own responses.

16. The method of claim 11, further wherein the content selection logic selects two or more students in a cohort for further interaction based on the student derived content.

17. The method of claim 16, further wherein the content selection logic selects the two or more users based on a semantic analysis of the student derived content such that the two or more students are selected based on opposing viewpoints expressed through the responses of the two or more students.

18. The method of claim 16, wherein the further interaction comprises a defined point where students in a cohort are loosely synchronized.

19. The method of claim 11, wherein the student derived content is a student response received based on a trigger point within a teaching element, the trigger point comprising an insertion point at a designated time within a teaching element where additional content is delivered.

20. The method of claim 19, wherein the trigger point is one of two or more trigger points, wherein each trigger point is associated with different content, and the content selection logic randomly chooses the trigger point and corresponding content to serve to the student.
